(19) United States
(12) Patent Application Publication
(10) Pub. No.: US 2018/0246479 A1
(43) Pub. Date: Aug. 30, 2018

(54) METHOD AND APPARATUS FOR STRATEGIC ENERGY SELECTION

(71) Applicant: Accion Power, LLC, Concord, NH (US)

(72) Inventors: Harold T. Judd, Concord, NH (US); Harris Burpee, Concord, NH (US)

(21) Appl. No.: 15/875,711

(22) Filed: Jan. 19, 2018

Related U.S. Application Data
(63) Continuation-in-part of application No. 13/537,595, filed on Jun. 29, 2012, now abandoned.

(51) Int. Cl. G05B 13/02; G06F 17/30; G06Q 30/08

(52) U.S. Cl. CPC G05B 13/0245; H02J 3/381; G06Q 30/08; G06F 17/30864

(57) ABSTRACT

A method and apparatus for providing secure, online centralized control over the selection of services and commodities to meet for example energy capacity for an electric generating plant, the method and apparatus providing screening and rejection of unqualified applicants, transparency exceeding governmental guidelines, options to aggregate offers, and facilitate automated, real time evaluation and ranking of energy producers.

### FIELD OF THE INVENTION

The present invention relates to a method and apparatus for providing secure, online centralized control over the selection of services and commodities to meet for example energy capacity for an electric generating plant, the method and apparatus providing screening and rejection of unqualified applicants, transparency exceeding governmental guidelines, options to aggregate offers, and facilitate automated, real time evaluation and ranking of energy producers.

### BACKGROUND OF THE INVENTION

The process of strategic energy planning for an electric generating plant encompasses continual analysis of qualified energy producers that can meet capacity, location, price and the required combination of non-renewables such as fossil fuel or nuclear power production with renewables such as solar, wind, and geo-thermal. Proper management of a competitive procurement program that meets all requirements of, for example, a regulatory agency for disclosure and transparency is one important factor that is extremely resource intensive. Every step in the process requires careful review and evaluation of information provided in numerous documents for the determination of acceptable candidates. Even during a pre-screening process, the discrimination and removal of energy producers that do not conform to the minimum offer requirements can be a lengthy and inefficient process. In many instances time and money is spent reviewing incomplete or non-conforming offers that are not ready for an adequate review because documents and information required to be submitted by the energy producer have not been completed. In many industries, a streamlined process that provides pre-screening of non-conforming offers, an easily accessible document management system and current status of all offers submitted would greatly reduce costs and overhead of managing and fulfilling the energy capacity requirements of an electric generating plant.

As an example, in the industry of electric power production, the deregulation of the electric utility industry has resulted in a need for a sophisticated and strategic energy planning to maintain and meet current and future energy needs. Power procurement in the electric utility industry is dominated by fixed price arrangements set according to federal and state regulatory and governmental bodies, as well as by tariffs filed with these regulators by the provider, and also as contractual arrangements between providers and end users. In most instances, the electric utility company will still maintain primarily the wires and other equipment constituting the local power grid over which electric power is transmitted to end user locations. The procurement of energy, for the electric utility company, may then be from solicitations from a combination of conventional generation facilities using nuclear, coal, and natural gas fuels and for all types of renewable resources, such as solar, wind and geo-thermal generation. Typically, energy producers are required to deliver for 10-30-year terms, making the reliability of electricity to customers dependent on selecting supplies that are financially and physically reliable for long terms.

Deregulation of utilities required the procurement of electricity and capacity from non-utility entities, and spawned the creation of non-regulated affiliates of many utilities. To ensure system reliability, many utilities have developed “self-build” proposals to supply system needs in the event the competitive market is unable to meet needs with reliable services at the lowest possible price for customers. Affiliate and self-build proposals compete with non-utility marketers, creating the challenge of conducting fair and transparent solicitations. The Federal Energy Regulatory Commission (FERC) and many state regulatory entities have standards to be met when affiliate or utility bids participate in competitive solicitations to ensure transparency, and to encourage the development of a robust competitive, non-regulated, power supply market. FERC and state standards require the monitoring of solicitations involving utility-affiliate bidding. Standards require transparency and accountability for conduct of such solicitations, and for the selection process. The standards are intended to prevent bias that would favor affiliate bids, and include requirements for record keeping giving regulators the ability to review details of the solicitation process.

The proliferation of “renewable portfolio standards”, intended to encourage the development of generation from non-fossil fuel sources, has resulted in the need to conduct frequent solicitations to accommodate small, diversified renewable generation. Development of renewable resources has also resulted in a significant increase in the number of participants in solicitations as the cost of developing diversified projects permits small firms to participate. This has resulted in the need to manage and evaluate many energy producers. For example, where previously there would be less than twelve qualified energy producers to build a large generating plant, there may be hundreds who respond to renewable product solicitations. In this as in many industries and government procurement programs, each of these solicitations must be transparent, secure, and fully documented to meet regulatory requirements. Conformance to these standards also protects a utility or other company from receiving corrective action notices from a regulatory agency, or from fines being levied for non-conformance, and/or from accusations from dissatisfied bidders that may result in project delay and/or in the worst cases costly, time consuming litigation.

The integrity of the electric grid is dependent on the availability of reliable energy sources. Further concerns for electric utility companies are that renewable resources, with intermittent, non-dispatchable power, create unique system challenges and demand rigorous performance standards. The low cost of small renewable projects attracts energy producers with limited experience and limited financial resources. However, where supply requirements are typically 10-30 years, long term planning and proven capabilities to maintain capacity and system reliability must be shown by these newcomers in the energy production market. Further, as renewable technologies evolve, even greater opportunities exist for market entry and with that the need for increasingly complex product designation and evaluation. Presently, in some solicitations over 1,000 offers are received, requiring increasingly more sophisticated ways to manage solicitations. All these submissions and all documents related to these submissions must be stored securely where confidential financial information may be provided.

The issues facing the energy production industry are like issues facing many other industries, such as within the government for military procurement, educational procurement, grant proposals for medical research and others where access to posted Requests for Proposal (RFP) and Requests for Information (RFI) are easily accessible to review and submit an offer, regardless of the ability of the energy producer to meet the most basic requirements. Procurement costs both within the private sector and government are driven up as resources are tasked with discerning competent acceptable energy producers from others. While many procurement programs accept electronically filed submissions, few provide any or very limited controls to restrict or remove non-conforming bidders early on in the process, a benefit that would greatly help to reduce resources and allow available resources to focus and better discern the offers provided by qualified bidders.

An important issue that has not been addressed in bid/proposal software platforms is that the requirements of each proposal may be vastly different from one another and therefore there is no standardization or conformity with for example the naming of file documents or the use of terminology where as an example even within a single industry some companies may refer to the proposal as an offer and others refer to the proposal as a bid. This may seem trivial where terms will certainly mean the same thing, but where hundreds of forms documents must be identified, correlated and compared as similar items, non-conformance in the naming of files or use of terminology can significantly increase time spent organizing documents prior to any time spent on evaluation of the qualifications of the bidder.

Differences in the bidding process from company to company may also leave a bidder unsure on the proper steps to take or files to be submitted, resulting in contacting the company to ask questions in order to complete their submission. While bid proposal software may provide a frequently asked questions page, the software may not provide an easily accessible process to enter a new question and distribute an answer and information to all bidders. A single individual may be answering the same questions repeatedly or sending emails out to each individual bidder to provide the information. This presents two distinct problems, first, the bid process must be fair and information that would help one bidder in theory must be provided to all bidders, a difficult task if a comprehensive list of all bidders has not been compiled; second, no favoritism should be shown to any one bid and a reviewer should not be compromised because they helped one bidder with a simple answer on a form. Most companies of course have controls to separate the administrators from the decision makers, but even any sense of impropriety may appear as unjust to a dissatisfied bidder. The ability of a company to fairly distribute information, answer questions and notify bidders of new dates or requirements is critical to maintain and meet the requirements of a fair competitive, bidding process, but currently most approaches again require significant resources to maintain this fairness.

What is needed is a method that tailors an offer proposal to a specific industry or need, and to a specific company within that industry. The method must further disseminate information fairly to all bidders and use information submitted to pre-screen bidders based on the basic requirements of the proposal. Further, security must be paramount, and all submissions and transactions must be maintained in a secure repository. The method must further allow access to submissions for review by both industry and regulatory authorities and allow the submissions to be ranked and qualified throughout the selection process to more efficiently and effectively select the most appropriate energy producers that meet and maintain the electric generating plant's capacity requirements.

### SUMMARY OF THE INVENTION

The method and apparatus of the present invention relates to a customizable procurement management and ranking system that may be used for any competitive procurement program providing centralized control over the entire solicitation and bidding process. The invention is suited to applications in the utility industry, military and industrial procurement, grant proposals, educational procurement, and other applications where accountability, data management, communication and transparency are required.

In a first embodiment, the method and apparatus are used to meet the need for sophisticated and strategic energy selection in response to the deregulation of the electric utility industry.

In this application, the method manages a competitive bidding process for the selection of services and commodities from electric generating plants to meet power and capacity requirements for immediate and expected use. In the first embodiment, the method further provides a comprehensive management tool to filter and rank offers from electric power producers of various types of power generation, such as from conventional generation facilities using nuclear, coal, and natural gas fuels and from all types of renewable resources, such as solar, wind and geo-thermal generation. The power generation providers may be within the electric utility company's local geographic region where the power is purchased at a point on the regional grid nearest the seller's generating facility. Alternatively, if the buyer is a local distribution utility, the power may be purchased on its local grid at a transfer point where the grid interfaces with the power grids of neighboring utilities. In either, geographic information such as latitude and longitude showing the location of the power generation facility may be helpful in the bidding process to determine the availability of a grid interconnection and transfer points for procurement of the power generated. The present invention provides an interactive map function that displays the location of each bid submission to quickly evaluate potential requirements for connection of an electric generation facility to the power grid.

The present invention provides security for confidential documents and anonymity of bidders while enabling an open and transparent bidding process with features such as off-site remote back up services that could protect data from natural disaster, accidental error or system failure. The secure platform further meets or exceeds security requirements for managing information deemed to be restricted for national security reasons, such as transmission grid and nuclear power plant details. The method includes features such as automatic communication with the bidders, collecting and tabulating bid data, managing bidder presentations and creating a permanent record of all solicitation activities thereby ensuring the integrity of the bidding process. The design and implementation of the method addresses the accountability and transparency requirements for electricity and capacity procurements for regulated utilities and meets or exceeds these regulatory requirements.

The method further eliminates the possibility of the submission of non-conforming, late or incomplete bids through the implementation of bid specific entry forms having range and threshold level parameters within each data field, to screen and prevent entries outside of the prescribed parameters. This filtering of non-conforming energy producers reduces the resources required by a utility company or other entity to review and screen non-conforming or incomplete bids and thereby delivers a significant improvement in efficiency to the bid process. An administrative module provides controls for twenty-four-hour access to the complete record or to relevant portions of the bid process to select individuals within a company, or to regulatory personnel within a government agency to monitor adherence to regulatory protocols during the bid submission process. Each activity, access to data, electronic message communications, etc. is tracked and audit reports are provided identifying the user and the activities performed during access to the bid processing system. The apparatus further provides automated, real time, bid evaluation and ranking, thereby responding to the need for timely decision making to meet the multi-year development schedule, after a decision is made to contract with a bidder.

The method and apparatus further support the submission of aggregate offers where two or more offers may be combined into a new bid as a new entity to meet for example capacity requirements. The method further supports inclusive offers where for example a reduced rate is provided if the solicitor accepts both bids, and for exclusive that restricts a concurrent bid from the same entity where the entity could not support for example the capacity requirements of more than one bid. Reporting and analysis features allow these types of bids to be reviewed in tandem with options to select any data field and configure data presented in reports for review. The system further provides ranking and statistical capabilities to assist in the selection of a bidder.

An object of the present invention is to ensure that all bidders have access to the same information at the same time twenty-four hours a day.

Another object of the invention is to provide an isolated data structure within the selected RFP, with no cross storing or access from any external entity.

Another object of the invention is to setup and manage multiple requests for proposals (RFP's) using a configure solicitation module or interface to configure bid terminology and set bid qualification parameters.

Another object of the invention is auto-transposable data fields within the configure solicitation module of a database structure to accommodate bid terminology specific to an agency, company or industry.

Another object is the ability to integrate graphics and file systems to allow the method and apparatus to be extensively customized for different projects, RFPs and RFIs.

Another object of the invention is the pre-screening and removal of bidders preventing or restricting access to bidders that do not meet pre-qualification parameters such as basic commercial viability standards, adequate financial support, enough proven performance capability, etc.

A still further object of the invention is the display of overlay maps showing latitude, longitude and other location information related to each bid submission.

A still further object of the invention is product specific proposal forms with range and threshold requirements for data entry.

Another object of the invention is to provide confidential communications between the solicitor and all anonymous bidders.

Another object of the invention is to provide a secure platform for uploading sensitive documents and information.

A still further object of the invention is the labeling of submitted documents in a standardized format that meets the terminology and bid parameter requirements.

A still further object of the invention is the organization and storage of each uploaded document and bid submission in a confidential offer or bid book specifically identified with a bidder.

A still further object of the invention is the implementation of a proposal specific RFP that may not be modified once active.

A still further object is the immediate shut down of a proposal specific RFP at the point of deadline for submissions.

A yet still further object of the invention is a notification and electronic messaging system that provides anonymous distribution of data and information to all parties.

A yet still further object of the invention is the access to all documents in appropriate formats for review, ranking and approval wherein bid submission data may be ranked based on a selection by a reviewer of data entry labels of interest.

A yet still further object of the invention is the ability to aggregate offers, create inclusive offers and exclusive offers.

A yet still further object of the invention is the creation of a permanent audit trail, that discloses each and every activity and transaction by any user accessing the procurement system.

The present invention is related to a non-transitory computer-readable media including computer instructions for implementing a strategic energy selection system to meet capacity for an electric generating plant, comprising electronic processing systems implemented on digital devices, the digital devices having a computer processors, memory, and data storage; the electronic processing systems comprising instructions for configuring an authentication interface accessible to one or more isolated data structures; the electronic processing systems communicatively coupled to a user interface and the electronic processing systems and user interface operable and comprising application software to implement instructions that receive, transform, transmit and display transactional data related to power supply requirements for an electric generating plant, the application software implemented on at least one database installed on a computer system having an internet connection accessible through the authentication interface; and comprising instructions of receiving specifications related to the power supply requirements of an electric generating plant, the power supply requirements comprising capacity requirements and a plurality of energy products; receiving capacity and a type of a plurality of energy products from a plurality of energy producers; activating a set of data fields related to one type of the plurality of energy products by implementing a configure technologies function of a configure solicitation module to configure data entry fields based on capacity and type of energy product received from one of the plurality of energy producers; verifying the capacity of each energy producer is within the capacity requirements of the electric generating plant; and denying access to the solicitation module to each energy producer having capacity outside of the capacity requirements; generating a plurality of qualification parameters related to the production of energy, each qualification parameter having a range and threshold based on requirements from the electric generating plant; receiving qualification parameter data from each of the plurality of energy producers that have capacity within the capacity requirements; generating a plurality of bid submission forms with each form comprising a plurality of qualification parameters specific to only one type of the plurality of energy products; displaying to one of the plurality of energy producers a bid submission form specific to the type of energy product of the energy producers thereby removing the requirement to enter qualification parameters that are not applicable to the energy producer; and selecting one of the plurality of qualification parameters as primary; selecting one of the plurality of qualification parameters as secondary; determining the value of each qualification parameter for each of the plurality of energy producers; filtering to display only energy producers that have the selected primary and secondary qualification parameters; ranking the energy producers by the value of the primary and secondary qualification parameters; and selecting an energy producer to supply energy to the electric generating plant based on their ranking. The isolated data structure prevents cross storing of data related to a specific energy producer; and the system may comprise generating a map site interface from qualification parameters of one of the plurality of energy producers; generating a document management module that defines a file folder structure to restrict uploaded documents provided from a specific energy producer to a directory structure and location specified within the bid submission form; configuring an electronic messaging module having an email management module, a distribution module configuring user attributes, a message generator and a notification generator distributing messages anonymously from the energy producers to the electric generating plant. The non-transitory computer-readable media including computer instructions for implementing a strategic energy selection system wherein the configure solicitation module constructs alternative terms as label attributes for a plurality of data entry fields within a database; the plurality of data fields configured to be autotransposable by selecting the alternative term label attribute to provide for every instance of a selected word to be changed to the alternative term in all of the plurality of data fields. In embodiments of strategic energy selection system, the range and threshold requirements are specific to the products and technologies of an energy producer and the pre-qualification requirements may have restrictive data entry fields to prevent access to specific energy producers that do not meet bid pre-qualification parameters. The strategic energy selection system may have the map interface display location information related to each specific energy producer. The strategic energy selection system may have data related to a specific energy producer stored in a confidential bid book. The document management module of the system stores and identically names uploaded documents in a standardized format specified by the bid submission form, the uploaded documents stored within the confidential bid book. The electronic messaging module of the system provides anonymous distribution of data and information to all parties. The strategic energy selection system further comprises at least one of aggregate offers, inclusive offers and exclusive offers.

The present invention is also related to a non-transitory computer-readable media including computer instructions for performing a method of selecting an energy producer to supply electricity to an electric generating plant comprising authenticating using a central processing unit (CPU) connected via a network to a remote storage device user accessibility to one or more isolated data structures in a remote memory device; querying at least one database on a computer system having an internet connection accessible to the isolated data structures to obtain transactional data related to qualification parameters comprising power supply requirements for an electric generating plant, the qualification parameters comprising capacity and technology requirements for different types of a plurality of energy products; generating an output for the selection of one type of the different types of the plurality of energy products; querying using the computer system a selection by one specific energy producer from a plurality of energy producers of one type of the plurality of energy products; compiling using the computer system product and technology data for each of the different types of the plurality of energy products; constructing using the computer system data entry fields based on the compiled data of the one type of the plurality of energy products selected by the specific energy producer; generating at least one bid form comprising one of at least prequalification parameters, a plurality of qualification parameters and company profile requirements, and the data entry fields compiled from the products and technology specific to the selection by the energy producer of the one type of the different types of the plurality of energy products; and wherein the plurality of qualification parameters related to the production of energy, each qualification parameter having a range and threshold based on requirements from the electric generating plant; displaying visually within a user interface using the computer system the data entry fields specific to the selection of one type of the plurality of energy products by the energy producer; querying using the computer system data specific to the one type of the plurality of energy products entered into the data entry fields by the specific energy producer; generating using the computer system a bid submission for the specific energy producer based on the query results, the bid submission comprising the data specific to only the one type of the plurality of energy products thereby removing data that is not applicable to the energy producer; selecting one of the plurality of qualification parameters as primary; selecting one of the plurality of qualification parameters as secondary; determining the value of each qualification parameter for each of the plurality of energy producers; filtering to display only energy producers that have the selected primary and secondary qualification parameters; ranking the energy producers by the value of the primary and secondary qualification parameters; and selecting an energy producer to supply energy to the electric generating plant based on their ranking.

The method of selecting an energy producer to supply electricity to an electric generating plant of may comprise storing the bid submission comprising data related to the specific energy producer within an isolated data structure; receiving prequalification parameters related to the power supply requirements of an electric generating plant, the power supply requirements comprising capacity requirements and a plurality of energy products; receiving capacity and a type of a plurality of energy products from a plurality of energy producers; activating a set of data fields related to one type of the plurality of energy products by implementing a configure technologies function of a configure solicitation module to configure data entry fields based on capacity and type of energy product received from one of the plurality of energy producers; verifying the capacity of each energy producer is within the capacity requirements of the electric generating plant; and denying access to the solicitation module to each energy producer having capacity outside of the capacity requirements. Embodiments of the method comprising constructing using the computer system alternative terms as label attributes for a plurality of data fields within a database; autotransposing using the computer system the plurality of data fields within the database by selecting the alternative term label attribute to change every instance of the selected word to the alternative term in all of the plurality of data fields. Embodiments of the method comprising constructing data entry product specific proposal forms with range and threshold requirements specific to the products and technologies of an energy producer. Embodiments of the method comprising displaying location information related to each energy producer with an icon identifying the type of energy product. Embodiments of the method comprising constructing a confidential bid book comprising the file folder structure specified within the bid submission form for storing bid submission data from the specific energy producer in a confidential bid book. Embodiments of the method comprising storing and identically naming uploaded documents in a standardized format specified by the bid submission form; storing uploaded documents within the confidential bid book. Embodiments of the method comprising sending electronic messages anonymously to distribute data and information to all parties. Embodiments of the method comprising accepting at least one of aggregate offers, inclusive offers and exclusive offers.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is a diagrammatic representation of a first embodiment of a computer system for a first embodiment of the procurement management system of the present invention;

FIG. 2 is a diagrammatic view of a first embodiment of a network system for a first embodiment of the procurement management system of the present invention;

FIG. 3 is a schematic representation of a first embodiment of an administrative structure for a first embodiment of the procurement management system of the present invention;

FIG. 4 is an embodiment of a solicitation access portal of a first embodiment of the procurement management system of the present invention;

FIG. 5 is an embodiment of a solicitation login screen for a first embodiment of the procurement management system of the present invention;

FIG. 6 is an embodiment of a company profile form for a first embodiment of the procurement management system of the present invention;

FIG. 7 is an embodiment of a prequalification flowchart for a first embodiment of the procurement management system of the present invention;

FIG. 8 is an embodiment of an acknowledgement form for a first embodiment of the procurement management system of the present invention;

FIG. 9 is an embodiment of a location requirements form for a first embodiment of the procurement management system of the present invention;

FIG. 10 is schematic representation of a first embodiment of the procurement management system of the present invention;

FIG. 11 is an embodiment of a bid management form for a first embodiment of the procurement management system of the present invention;

FIG. 12 is an embodiment of an offer book for a first embodiment of the procurement management system of the present invention;

FIGS. 13A and 13B are embodiments of a bid form template for a first embodiment of the procurement management system of the present invention;

FIG. 14 is an embodiment of an access portal to an administrator module for a first embodiment of the procurement management system of the present invention;

FIG. 15 is a schematic diagram of an administrator module for a first embodiment of the procurement management system of the present invention;

FIG. 16 is an embodiment of a configure solicitation module for a first embodiment of the procurement management system of the present invention;

FIG. 17 is an embodiment of a configure technologies module for a first embodiment of the procurement management system of the present invention;

FIG. 18 is an embodiment of an administrator menu for a first embodiment of the procurement management system of the present invention;

FIG. 19 is an embodiment of a content display function for a first embodiment of the procurement management system of the present invention;

FIG. 20 is an embodiment of a configure frequently asked questions (FAQ) function for a first embodiment of the procurement management system of the present invention;

FIG. 21 is an embodiment of a configure question and answer (Q & A) function for a first embodiment of the procurement management system of the present invention;

FIG. 22 is an embodiment of a configure announcement function for a first embodiment of the procurement management system of the present invention;

FIG. 23 is an embodiment of a configure calendar function for a first embodiment of the procurement management system of the present invention;

FIG. 24 is an embodiment of a configure document display function for a first embodiment of the procurement management system of the present invention;

FIG. 25 is an embodiment of an upload management function for a first embodiment of the procurement management system of the present invention;

FIG. 26 is an embodiment of a customizable bid form for a first embodiment of the procurement management system of the present invention;

FIG. 27 is an embodiment of a flow chart for customizing a bid form for a first embodiment of the procurement management system of the present invention;

FIG. 28 is an embodiment of a view bids function for a first embodiment of the procurement management system of the present invention;

FIG. 29 is an embodiment of a bid book template for a first embodiment of the procurement management system of the present invention;

FIG. 30 is an embodiment of a user management module for a first embodiment of the procurement management system of the present invention;

FIG. 31 is an embodiment of schematic diagram of an email management module for a first embodiment of the procurement management system of the present invention;

FIG. 32 is an embodiment of an email response template for a first embodiment of the procurement management system of the present invention;

FIG. 33 is an embodiment of an email distribution generator for a first embodiment of the procurement management system of the present invention;

FIG. 34 is an embodiment of a bid number list for a first embodiment of the procurement management system of the present invention;

FIG. 35 is an embodiment of an access portal for a reports/logs module for a first embodiment of the procurement management system of the present invention;

FIG. 36 is an embodiment of a configure bid report layout module for a first embodiment of the procurement management system of the present invention;

FIG. 37 is an embodiment of a generate bid report module for a first embodiment of the procurement management system of the present invention;

FIG. 38 is an embodiment of a configure status report layout module for a first embodiment of the procurement management system of the present invention;

FIG. 39 is an embodiment of a generate status report module for a first embodiment of the procurement management system of the present invention;

FIG. 40 is an embodiment of a response email report module for a first embodiment of the procurement management system of the present invention;

FIG. 41 is an embodiment of a map of site function for a first embodiment of the procurement management system of the present invention; and

FIG. 42 is an embodiment of a configure map of site label function for a first embodiment of the procurement management system of the present invention.

### DETAILED DESCRIPTION OF THE INVENTION

In the method and apparatus, a customizable procurement management and ranking system implemented on an internet or intranet database platform is described. Some embodiments of the present invention will be described in terms that would ordinarily be implemented as software programs. Those skilled in the art will readily recognize that the equivalent of such software may also be constructed in hardware. Because data manipulation algorithms and systems are well known, the present description emphasizes algorithms and features forming part of, or cooperating more directly with the method and hardware of the presently disclosed invention. General features of databases, digital communications devices, email and computerized systems are likewise well known, and the present description is generally limited to those aspects directly related to the method and related hardware of the invention. Other aspects of such algorithms and apparatus, and hardware and/or software for producing and otherwise processing the data involved therewith, not specifically shown or described herein may be selected from such systems, algorithms, components, and elements known in the art.

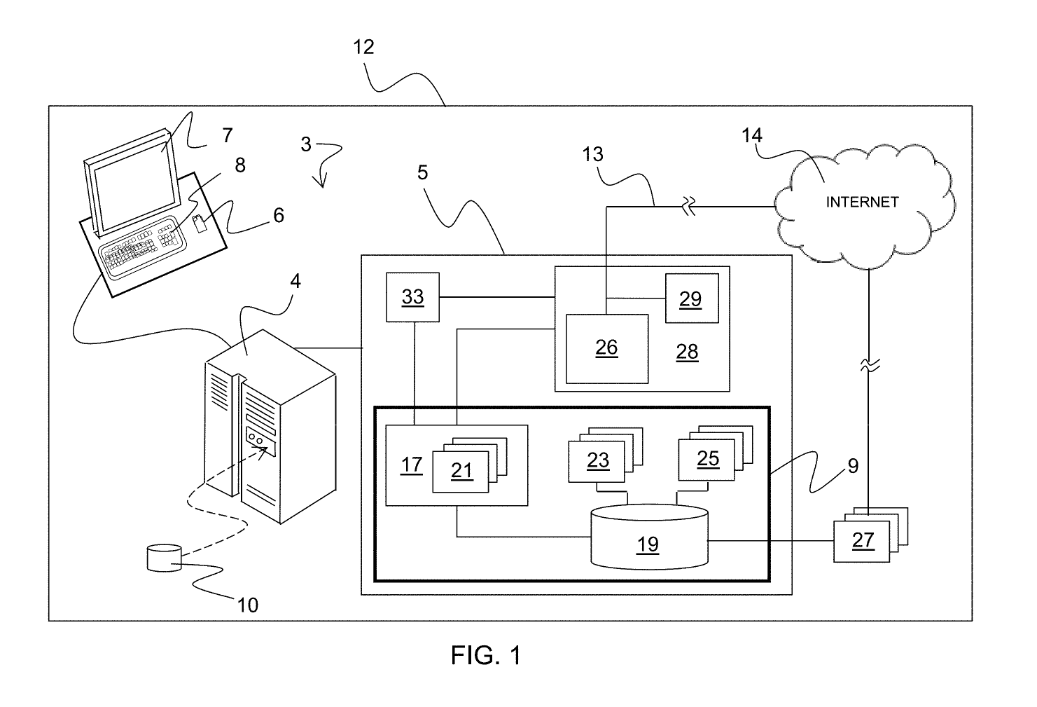

The present invention can be implemented in computer hardware and computerized equipment. For example, the method can be performed using a system including one or more digital communications devices and/or one or more personal computers. Referring to FIG. 1, there is illustrated a computer system 3 for implementing the present invention. Although the computer system 3 is shown for illustrating a preferred embodiment, the present invention is not limited to the computer system 3 shown, but may be used with any electronic processing system such as found in digital communications devices, cellular phones and other mobile devices, home computers, or any other system for the processing of digital data. The computer system 3 includes a server computer 4 having a microprocessor-based unit 5 (also referred to herein as a processor) for receiving and processing software programs and for performing other processing functions. An output device 7 such as a visual display is electrically connected to the microprocessor-based unit 5 for displaying user-related information associated with the software, e.g., by means of a graphical user interface. A keyboard 8 is also connected to the microprocessor-based unit 5 for permitting a user to input information to a software program. As an alternative to using the keyboard 8 for input, a mouse 6 may be used for moving a selector on the display 7 or alternatively a touch screen input device may be provided for selecting an item.

The output device 7 provides visually to the user transactional data that has been subject to transformations. The output device 7 can be a monitor or other visual computer screen or graphical user interface (GUI), a printer or other output device that provides a visual or other representation of a final output from the microprocessor-based unit 5. The output device 7 can also be an output device that provides the transactional data as a digital file.

The microprocessor-based unit 5 provides means for processing the transactional data to produce readily discernable, informational and organized images and data on the intended output device or media. The present invention can be used with a variety of output devices that can include, but are not limited to, a digital photographic printer and soft copy display. Those skilled in the art will recognize that the present invention is not limited to just these mentioned data processing functions. The server computer 4 shown in FIG. 1 can store a computer program product having a program stored in the computer readable storage medium 10, which may include, for example: magnetic storage media such as a magnetic disk (such as a floppy disk) or magnetic tape; optical storage media such as an optical disc, optical tape, or machine readable bar code; solid state electronic storage devices such as random access memory (RAM), read only memory (ROM) or flash memory data storage devices. The associated computer program can also be stored on any other physical device or medium employed to store a computer program indicated by offline memory device.

It should also be noted that the present invention can be implemented in a combination of software and/or hardware and is not limited to devices, which are physically connected and/or located within the same physical location. One or more of the devices illustrated in FIG. 1 can be located remotely and can be connected via a network 13. One or more of the devices can be connected wirelessly, such as by a radio-frequency link, either directly or via a network 13. It is to be appreciated that such devices can be mobile devices (e.g., camera, PDA, iPod, iPad, tablet computer or cell phone that can be used as a processing unit, a display unit, or a unit to give processing instructions), and as a service offered via the World Wide Web 14.

In each context, the invention may stand alone or may be a component of a larger system solution. Furthermore, human interfaces, e.g., the input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the method of the invention can be fully automatic, may have user input (be fully or partially manual), may have user or operator review to accept/reject the result, or may be assisted by data or metadata (data or metadata that may be user supplied, supplied by another computer program or database from a different application or determined by an algorithm). Moreover, the algorithm(s) may interface with a variety of workflow user interface schemes.

In the following description, some features are described as “software” or “software programs”. Those skilled in the art will recognize that the equivalent of such software can also be readily constructed in hardware. Because data manipulation algorithms and systems are well known, the present description emphasizes algorithms and features forming part of, or cooperating more directly with the method and hardware of the presently disclosed invention. General features of databases, digital communications devices, email and computerized systems are likewise well known, and the present description is generally limited to those aspects directly related to the method and related hardware of the invention. Implementation of the present invention may be in conjunction with one or more database management systems (DBMS) such as Oracle, IBM DB2, Microsoft SQL Server, PostgreSQL, MySQL, or others using widely supported database languages such as SQL to define and manipulate data and perform data queries. Other aspects of such algorithms and apparatus, and hardware and/or software for producing and otherwise processing the data involved therewith, not specifically shown or described herein may be selected from any such systems, algorithms, components, and elements known in the art. The present invention may further be implemented on a secure web server 9 using SSL, SHTTP or other security protocols for encryption and decryption of transmitted data. Data replication and redundancy is performed automatically, and all servers are secured in optimal conditions. Further security is provided wherein each proposal is setup using a unique domain name that is active solely during the prescribed period for accepting bids, and is immediately deactivated at the close of bid acceptance. At bid close, the entire database with all data is ported to a storage unit and provided to the solicitor as a secure record of all bid submissions, communications and transactional data of the solicitation.

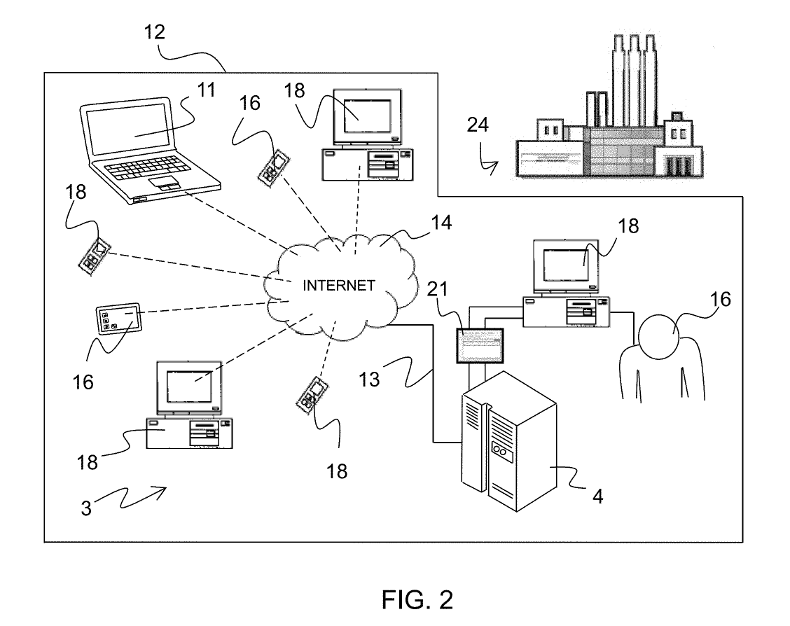

As described briefly above, in a first embodiment, the present invention is directed to an apparatus and method for efficient management of a bidding process for bidders to provide power generation offers to solicitations as requested by utilities to meet the utilities power supply requirements and commitments. The invention provides for security of confidential documents enabling an open and transparent bidding process for all participants and specifically facilitates automatic communication with the bidders, collects and tabulates bid data, manages bidder presentations and creates a permanent record of all solicitation activities for later review and regulation requirements. While a first embodiment of this application is generally drawn in an exemplary manner to a solicitation and bidding process for electricity production, it is to be appreciated that the same method and apparatus could be used to solicit and bid for almost any commodity, good or service. In the first embodiment as shown in FIGS. 1 and 2, the solicitation and bid system, indicated diagrammatically as 12, would include the above described computer system 3, application software 17, one or more databases 19 including at least a form template database 21, bid requirements database 23, and a bid submission database 25 including registrant contact information, completed bid data, and bid status information. The system further includes a communication/email management module or interface 28 that will be described in more detail below. Access to external data records and/or databases 27, for example access to regulatory information may also be provided. User and registrant logins and preferences would link specific user information to a user identification to provide predetermined access to information for each user or registrant. An administrative module 33 within the application software 17 controls, for example, data access to add, monitor, restrict or remove users; to configure distribution lists for electronic messaging communication; and to evaluate content and/or to restrict or reject incomplete or non-conforming bid submissions to the solicitation management system 12. For purposes of clarity, the term “user” may include but is not limited to pre-registered or registered bidders, solicitors, regulatory agents, system administrators and/or a non-registered power producer interested in information and status regarding the solicitation. The administrative module 33 controls access to information for each type of user.

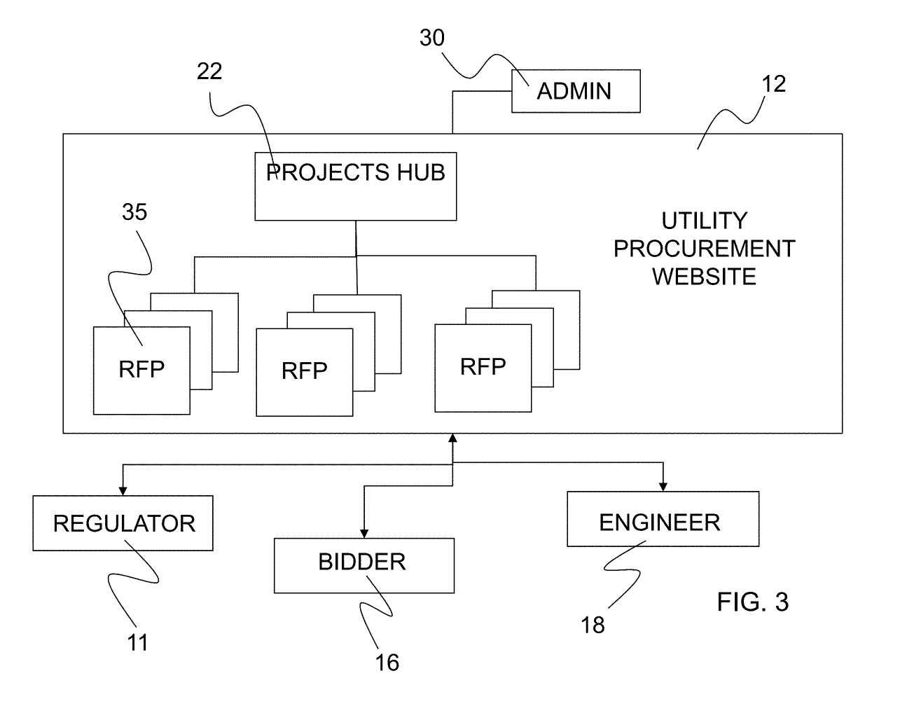

The secure web-based platform of the present invention, as shown in FIG. 2, provides access to solicitation information using any internet accessible device allowing any interested party such as energy producers 16 interested in responding to the solicitation; engineers 18 of the solicitor who will analyze and review bid submissions; and/or regulators 11 auditing the bid process for adherence to regulatory requirements. A power producer 16 interested in a solicitation may access the secure website of the solicitation to review information and enter data. As discussed above, today a utility company 24 may want to solicit bids not only from conventional nuclear, coal and natural gas entities, but may also desire bids from renewable sources such as wind, solar and geo-thermal generation facilities. To meet its customers' needs, the utility 24 must put its power requirement “on the street” by going out to the industry and soliciting bids for a specific power supply project, this is called a solicitation. The utility 24 generally does not have enough internal resources to administer the solicitation which, as noted previously, can be upwards of 1,000 bids on any given solicitation. The present invention provides a solicitation platform from which an administrator 30 can easily and efficiently control and monitor the bid process as well as ensure that the information to each energy producer 16 is impartial and transparent. As shown in FIG. 3, the administrator 30, who may or may not be a utility employee, controls the entire process and apparatus used to offer the solicitation, procure the power production bids and disseminate information. The administrator 30 may post information of one or more of the utility company's RFP's 35 that are active or planned RFP's (posted prior to requesting bid submissions). As a utility 24 determines internally its needs and requirements for the power it needs to supply to its customers, the administrator 30 of the solicitation management system 12 begins configuring the form templates 21 and range limitations necessary to meet these power requirements as described in further detail below.

The administrator 30 directly controls the content/site management and through this module controls and edits the basic website settings and content including configuring bid parameters, managing the facts, e.g. FAQ's, capacity requirements, and other information that must be collected from bidders regarding the solicitation to properly evaluate and select an appropriate bidder. The administrator 30 further controls question and answer (Q&A) information, announcements, timelines/calendar and documents available on the website to the registrants and bidders. It is also to be appreciated that the terms registrant and bidder may be used interchangeably throughout the specification as a bidder by necessity must be registered to supply a bid and be part of the solicitation process. The administrator 30 also controls a bid management module or interface 180 through which the administrator can build and generate prequalification and qualification parameters, company profile requirements, product information, bid form databases, configure products and technologies, and configure a bid book folder structure for uploading and storing documents. The administrator 30 may further view and manage existing bids in the queue.

A user management module 200 allows the administrator 30 to view registrant records and approve manual registrations. This module permits the viewing, editing, enabling and disabling of user records and manages user security parameters to provide access and/or restrict or lockout users for non-approved activity using a user's IP address or other system identifier.

The administrator uses an email management module 210 to create content for, and generate individual and group emails as necessary. While generally used to inform registrant and bidders of ongoing and critical solicitation activity, the email management may also be utilized for communication of information with non-registered users who have requested notification with respect to a solicitation. A reports/logs module 240 allows an administrator 30 to configure and generate bids, users, email reports, view site access and email generation logs, view site contact and activity logs, manage site maps, and create “in-service” sites or other iconic indicators to be included on a map of, for example, potential energy production facility sites. A more complete discussion of the above noted modules and features of the present invention are discussed in detail below.

An important feature of the present invention is the creation of a dedicated secure website for each new solicitation that includes all information and details of the solicitation. Alternatively, multiple solicitations could be presented through a single existing website, but for security and control a single solicitation within a single website domain allows for access to the site to be activated precisely when bid submissions are accepted and be deactivated precisely when bid submissions are no longer accepted. The website further provides for all data including the bid submissions and communications to be ported to a secure server for storage and recordkeeping after the website has been de-activated. The administrator 30 can customize each solicitation page using the content/site management module 170 as discussed in further detail below.

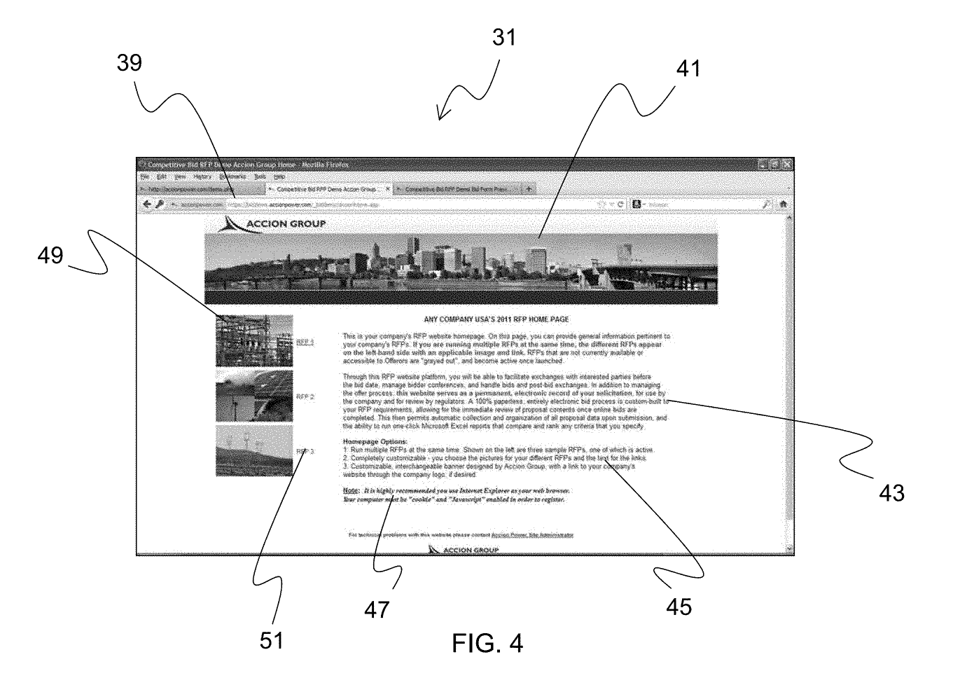

An RFP home page 31, as shown in FIG. 4, provides an access portal for bidders to select and enter one or more RFP bid forms. The administrator 30 may configure the home page 31 with a company logo 39 and company picture 41. General information 43 on the solicitations, options for display 45 on the home page and important access information 47 for the website may be shown. A picture, drawing or other graphic 49 may be selected and configured by the administrator 30 for each RFP 35. Using the system 12, a utility company may run and manage concurrent RFPs that have different start dates, end dates and capacity requirements, with access to the data of each RFP 35 separate and secure from any other RFP. Documents submitted for review as described in further detail below are saved within an isolated data structure within the selected RFP 35, with no cross storing or access from any external entity.

This restricted access to data of a single RFP is unlike other file systems of the prior art where a set of documents from one RFP are stored in one or more folders in a tree like file structure on a single server. The folder and files of multiple RFPs are accessible to anyone who has access to the server and creating a security risk and potential for misfiling by saving data in an incorrect folder. The solicitation management system 12 excludes access to all other folders and files except those associated with the selected RFP. This improvement on current data file structures restricts access to highly confidential information to only those administrators and reviewers of the selected RFP and prevents access or filing errors of documents where another RFP could be mistakenly selected.

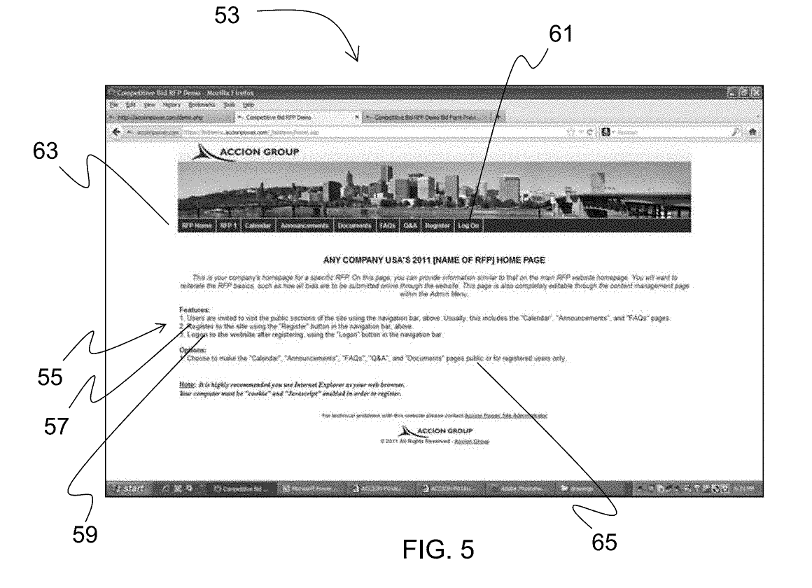

An RFP hyperlink 51 provides access to an introduction screen 53 for each RFP 35 as shown in a first embodiment in FIG. 5. Features 55 of the RFP are described with options for access to public areas of the site that anyone may review to determine if they have an interest in the solicitation. A hyperlink for bidder registration 57 and bidder login 59 may be provided or an energy producer 16 may be directed to select a logon tab 61 on a navigation bar 63 to access these features. An energy producer 16 must be registered to receive access to the RFP bid form 37. Other display options 65 may be configured to restrict or allow public or private access to specific features of the website such as access to calendar dates, announcements, FAQs, Q & A and other sections of the solicitation management system 12.

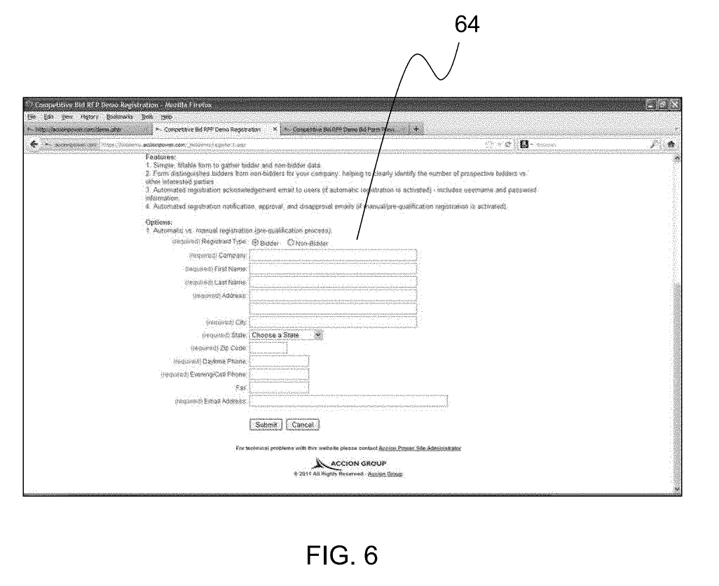

An important feature of the solicitation management system 12 is the ability for an energy producer 16 to pre-register for RFPs of interest prior to the RFP becoming active and accepting bid submissions 85. Registration may be automatic for pre-approved bidders, based upon administrator setup and lists of known bidders. A bidder will receive a username and password by submitting a registration submission form 51 requesting information to be used in a company profile for the bidder as shown in FIG. 6. Alternatively, registration may be configured for manual registration where a pre-qualification form 67 must be submitted and reviewed to determine if an energy producer 16 meets a series of pre-qualification parameters to be approved for registration. As noted above, filtering solicitations early can greatly reduce resource requirements needed to review non-conforming bids. In a first embodiment of the present invention, access to the solicitation website of a utility company 24 is open to the public and information from the solicitation monitoring system 12 initially presents information on upcoming RFP's. In a first embodiment, an energy producer 16 may review this information and choose to pre-register as a bidder for the solicitation. To pre-register, the energy producer 16 must complete a pre-qualification bid form 67. The pre-qualification form 67 lists the basic requirements that are necessary to register for the solicitation. Each data entry field of the form includes maximum and minimum requirements that must be met to gain acceptance to registration as an energy producer for the solicitation. For example, a requirement may be that the energy production facility is within a region accessible to the available power grid. The energy producer 16 may enter the latitude and longitude of the energy production facility, and if this is within the acceptable region, the bidder will pass this criterion of the pre-qualification. If this area is outside of the acceptable region the user will not be accepted as a registered bidder. A further requirement may be the length of time the energy production facility has been in operation to assist in the assessment of the user as a qualified bidder. Entries that meet the pre-qualification requirements of the solicitation allow the bidder to be pre-registered. Pre-registration adds the user to a distribution list that will receive notification of the official posting of the RFP and allow the bidder to be registered when the RFP becomes active.

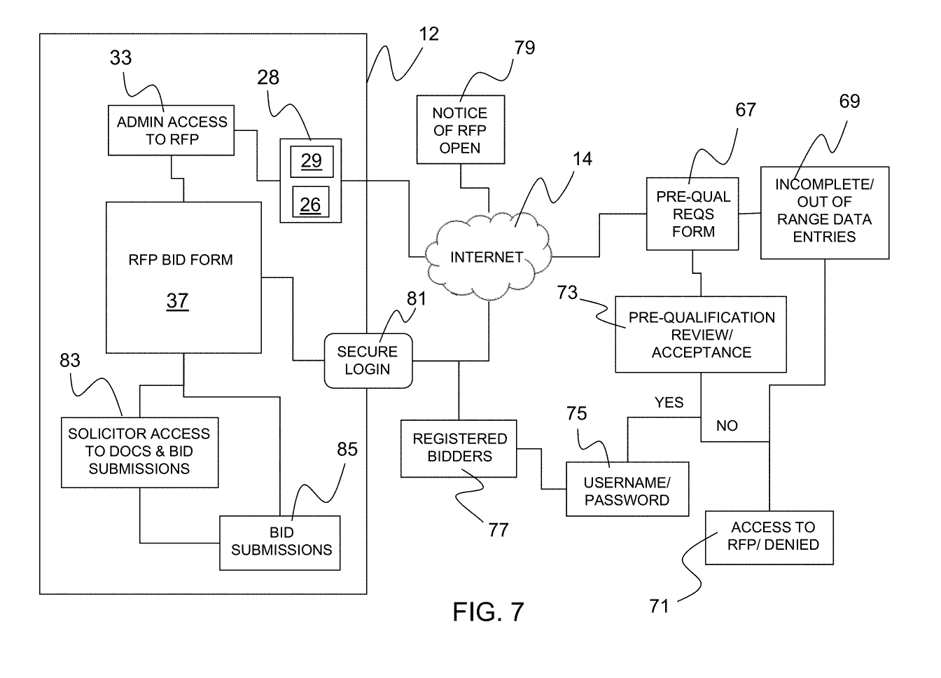

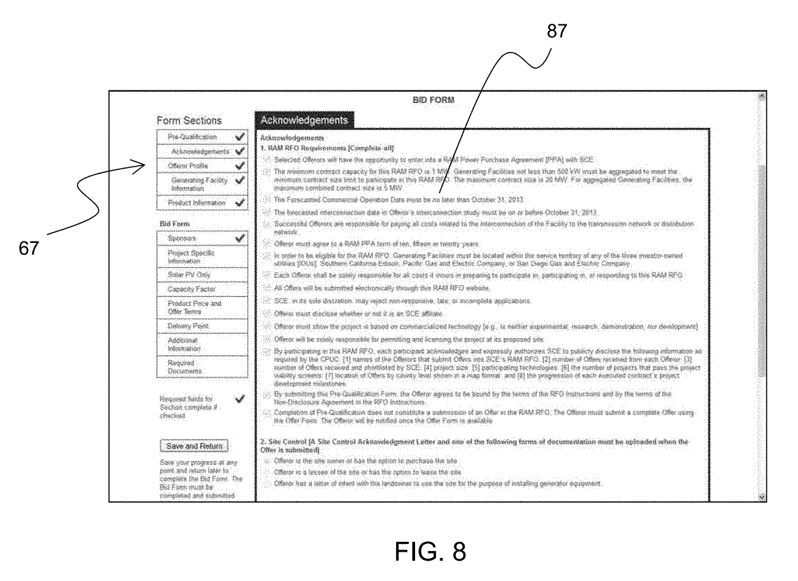

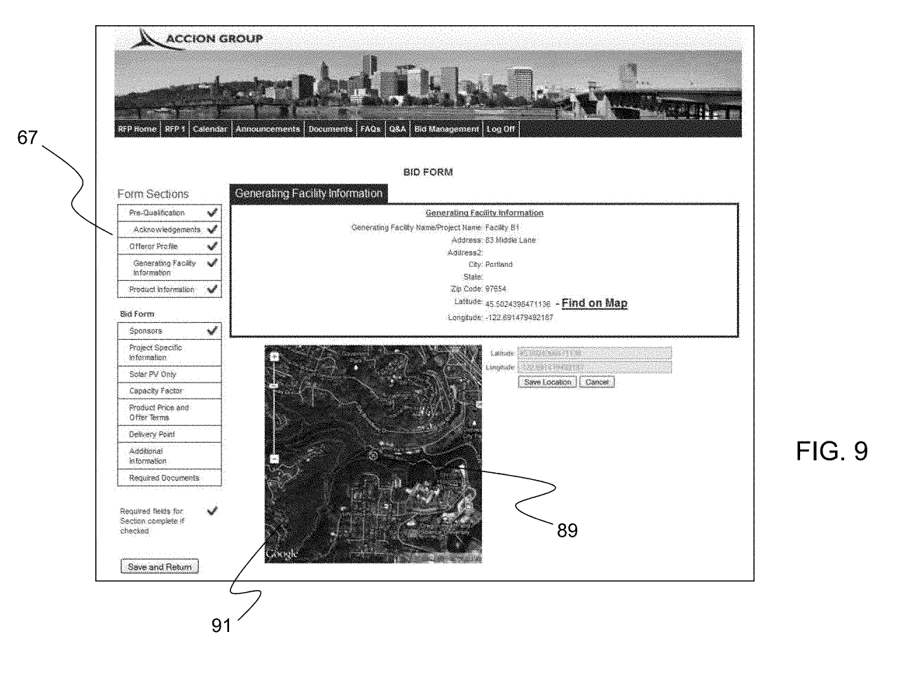

As shown in FIG. 7, the energy producer 16 enters information that may include power production resource specifications, system impact study information, location of the energy production facility, proof of ownership and other criteria that help to ensure that only energy producers meeting the pre-qualification parameters can register for the solicitation. The data fields of the prequalification bid form 67 may be configured to include specific ranges preventing data entry outside of the acceptable range. Requirements may further be presented as acknowledgements 87, as shown in FIG. 8, where all boxes must be selected by the energy producer 16 to affirm that their facility meets all prequalification parameters. The prequalifications may further require an entry of latitude and longitude information as shown in FIG. 9. The solicitation management system 12 integrates this location information with mapping display programs 91 such as Google maps to display the location of the energy production facility 89. A critical requirement as noted above is that a facility 89 be within a required geographic location and be accessible to the power grid for transmission of the electric power. It may be unfeasible to connect facilities 89 that are out of the specified region and are not already connected to the power grid. While proprietary grid and transformer information may not be displayed, the visual map display 91 allows a reviewer 73 of the prequalification parameters to quickly determine if the facility is accessible to the power grid.

If a form 67 is submitted with incomplete acknowledgements or unacceptable data field entries 69 a notice 71 is automatically provided to the energy producer 16 indicating access to the RFP site has been denied. Alternatively, the submitted prequalification form 67 may be reviewed for acceptance 73 by the administrator 30 or an engineer 18 or other member of the utility company and a decision may be made, and a notification sent to the energy producer 16. The accepted bidder 77 is provided with a username and password 75 allowing them to be registered giving them access to the solicitation. A registered bidder 77 may then access the secure authentication interface 81 and login to view the RFP bid from 37 to enter data that will be reviewed by the solicitor 83 and be compiled as a bid submission 85 as described in further detail below.

For RFPs that have been posted prior to becoming active and accepting bids, announcements and other information about the solicitation may be sent to all registered bidders 77 using the communications management system 28. Upon activation an activation notices 79 is sent to all registered bidders 77 and solicitor reviewers 83 telling them the RFP is open and accepting bid submissions 85. Upon activation, access to the bid form 37 and other solicitation information is available to registered bidders 77 and other interested parties twenty-four hours a day with access to the same information at the same time being equal to all bidders 77 until the deadline for submission when the system 12 is inactivated. At this precise time, no modifications to bids or further bids may be made or submitted.

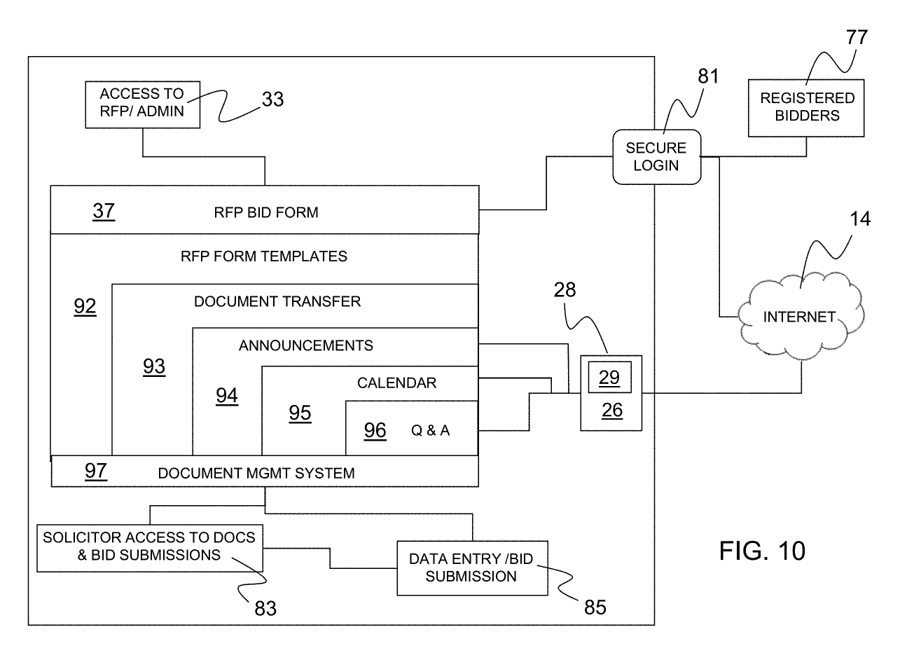

The RFP bid form 37 provides a set of modules to assist in facilitating data entry, communication, and document transfer. The modules include a number of functions as shown in FIG. 10 including RFP form templates 92, document transfer modules 93 to receive and send documents to and from the solicitation management system 12, an announcements module 94 to create notices, a calendar module 95 showing critical dates, a question and answer module (Q & A) 96 to respond to bidder's questions, and a document management module 97 to organize and access documents and data provided by each bidder 77. As described in further detail below, a communications module 28 provides electronic messaging including questions or comments from the registered bidders 77 to administrators 30 and authorized users of the solicitation management system 12 in an anonymous fashion. In this way a response from the administrator or from a solicitation reviewer 83 is distributed using notification emails and/or posted to the FAQ's and Q & A's for all bidders 77 to access the information provided simultaneously, significantly reducing time spent in responding to the same or similar questions repeatedly and removing any perception of favoritism or partiality of a reviewer to one or more bidders.

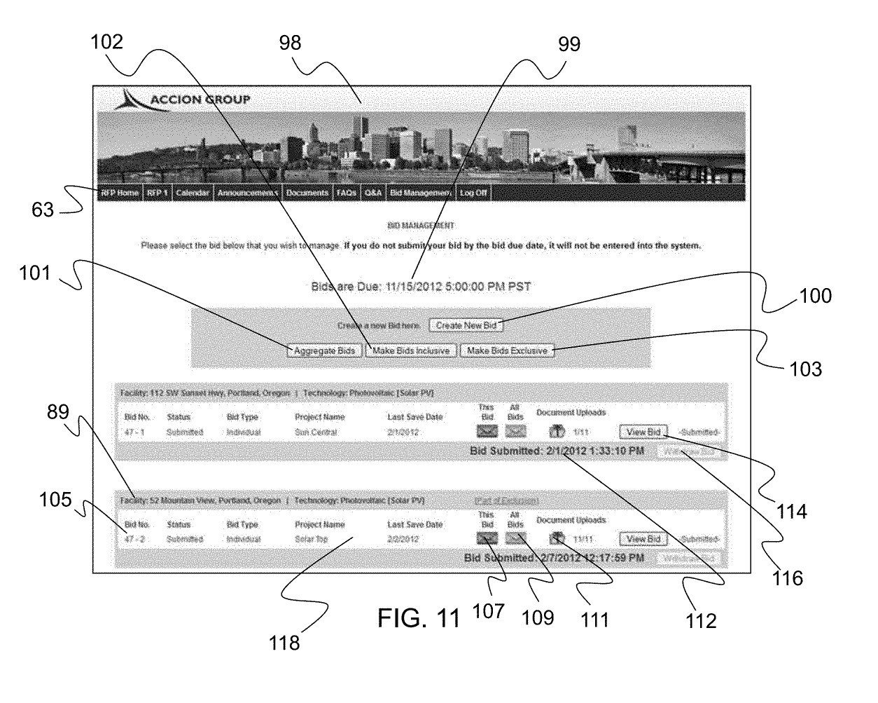

The RFP bid access portal 98, as shown in FIG. 11, displays the bid due date 99, a navigation toolbar 63, an option to create a new bid 100, and options to aggregate bids 101, make bids inclusive 102, or make bids exclusive 103 as explained in greater detail below. A list of each energy production facility 89 that is registered with a bid number 105 is shown with access keys to select and view the current bid 107, view all bids 109 submitted by the energy production facility 89 and to upload documents 111. The bid submission date 112 and an access key to view the current bid form 114 are also shown. A further option to withdraw a bid 116 is available with all access tools for each bidder presented and easily accessible within each registered bidder dialog box 118.

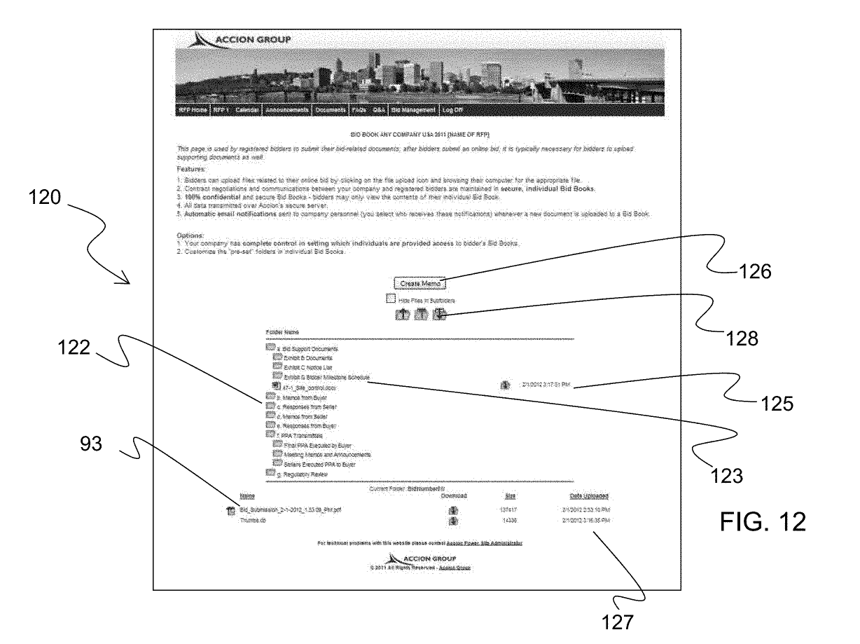

By selecting the current bid 107 as shown in FIG. 12, a bid book 120 of the currently submitted bid is shown. A bid book 120 is a completely secure access point to data and information provided within the currently submitted bid that is only accessible to the registered bidder 77 and reviewers 83 of the utility company 24. The bid contents are not accessible to any other registered bidder and access may further be restricted to only designated reviewers 83 using the administrator tools 33. The bid book 120 provides a document management system 122 that organizes each completed bid form and uploaded document. An important feature of the document management system 122 is the data tree structure that upon upload of a document changes the document name and location to a file name and location defined by the utility company and administrator when setting up the bid. In this manner all required documents from each registered bidder 77 are named identically and can be accessed from the same point in the document management system 122. For example, the bidder 77 reaches a point within the bid form 37 that requests a document supporting the bid be uploaded, for example a milestone schedule 123. The bidder 77 browses and selects a document locally stored on their server system that may be named Project Timeline and uploads the document. The document is uploaded to section a specific section such as “Section a, exhibit g” of the document management system 122 and renamed as the “Bidder Milestone Schedule” thereby reducing time and resources spent reviewing and correlating documents of different file names submitted from different bidders. The document management system 122 also provides indicators 125 to bidders and reviewers to clearly show with a time and date stamp when a document has been uploaded.

The bid book 120 further provides access to the communications management system 28 using the create memo access key 126 and viewing tools 128 that manage the document folder and subfolder lists to more easily find and access the large number of documents submitted with the bid. Access to uploaded documents is also provided in the document transfer system 93 that provides a list of all uploaded documents and allows a reviewer 83 to download a document for further analysis. Date and time stamps 127 are also provided for the upload of each document to the system. An audit trail of every transaction by any user of the system is also provided as described in further detail below.

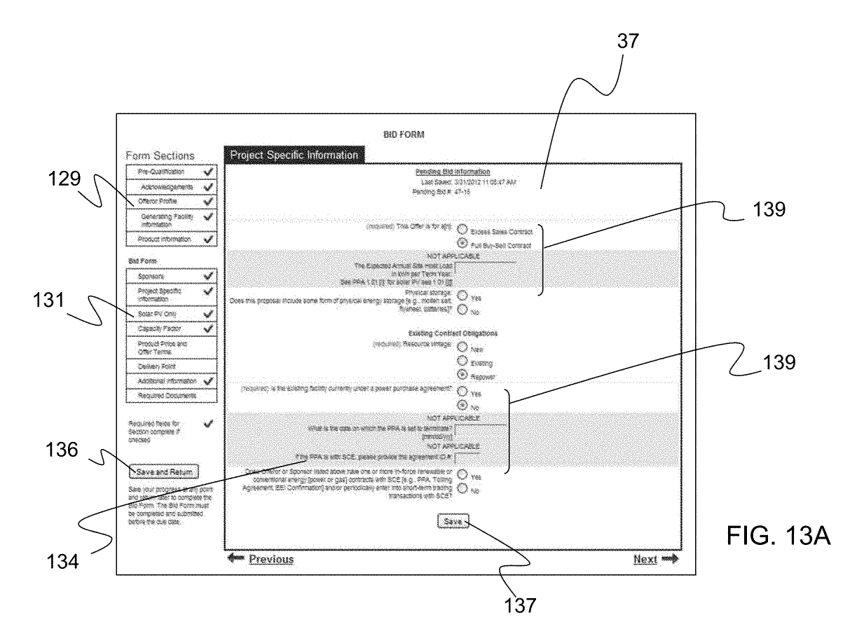

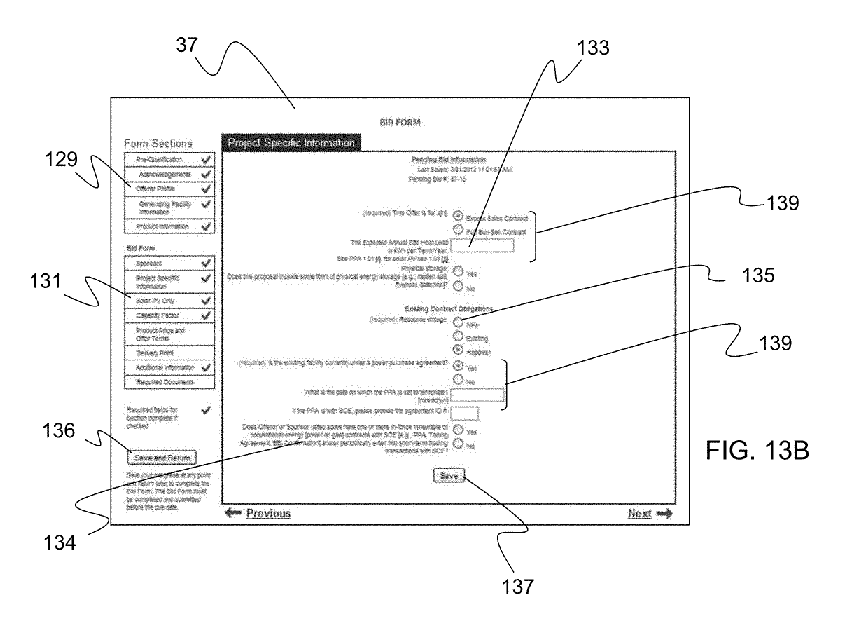

The view bid button 114 may be selected to access the bid form templates 92 that list the information and requirements that must be provided by each registered bidder 77 for review by the solicitor 83 as shown in FIGS. 13A and 13B. In a first embodiment, the bid form 37 displays the prequalification menu 129 and the bid menu 131 that provides for navigation through the pages of the bid form 37. The bid pages are designed for the type of energy production such as wind, solar or geothermal of the energy producer (bidder 77) and data entry fields 133 or radio buttons 135 are tailored to request bidder information specific to the energy production requirements of the solicitation. Detailed instructions 134 are provided to clearly explain the type of information to be entered or acknowledged and affirmed to. A data entry field 133 may permit only a number value as an entry and may specify in the instructions 134 for example a specific requirement such as the “Expected Annual Site Host Load in kWh per Term Year”. Radio buttons 135 may provide simple yes or no options, or list options, and allow for only one option to be selected or allow for all that apply to be selected based on the bid requirements. A save and return 136 and save button 137 allow the bidder 77 to enter and save data and then close the current bid form page and return later to edit or add additional information prior to submission of the bid.

Providing a customized predetermined bid form 37 for any given solicitation is an important aspect of the present invention. Using specific terminology that conforms to the company's standards, as described in further detail, while also providing the flexibility to select specific data fields necessitated by the solicitation, allows RFPs to be quickly created and to be secured so that modifications to the bid form 37 may not be made once the solicitation is activated. In this way the same information at the same time is consistently presented to all bidders, an important mandate for transparency and equality in the bidding process.

The customized predetermined bid forms 37 further implement range dependent and threshold level data fields 133 with detailed instructions 134 for each data entry required to assist in evaluating the bidder as a viable candidate. Commercial viability standards, adequate financial support, and proven performance capability must all be shown to permit a bidder to meet and be considered to receive the offer of the solicitation. Each of the pre-qualification bid form sections and registered user bid form sections within the solicitation may further use distinctive go-no-go fields 139. In this way if an answer is entered that is outside the required range or criteria set within the data field, other data entry fields 133 may remain gray and block data entry as shown in FIG. 13A. An entry that is within the required data range or criteria will activate and require further data to be entered with information relating to the acceptable entry. For example, a listing of capacity requirements for different energy products may be displayed. The bidder 77 may select an energy product and enter their available capacity. The energy product entered will activate a set of data fields related to that type of energy product, such as if wind power is selected as the energy product then further data entry fields 133 may ask for information on the number of available turbines, blade lengths or other information to support the entered capacity requirements. A selection of a different energy product such as solar may activate other data entry fields specific to that product. The ability to modify the bid form 37 based on information provided by the bidder 77 in real time provides for bid submissions that include only the required information specific to that bidder 77, saving a reviewer time from scanning other entries that are entered as N/A or not applicable.

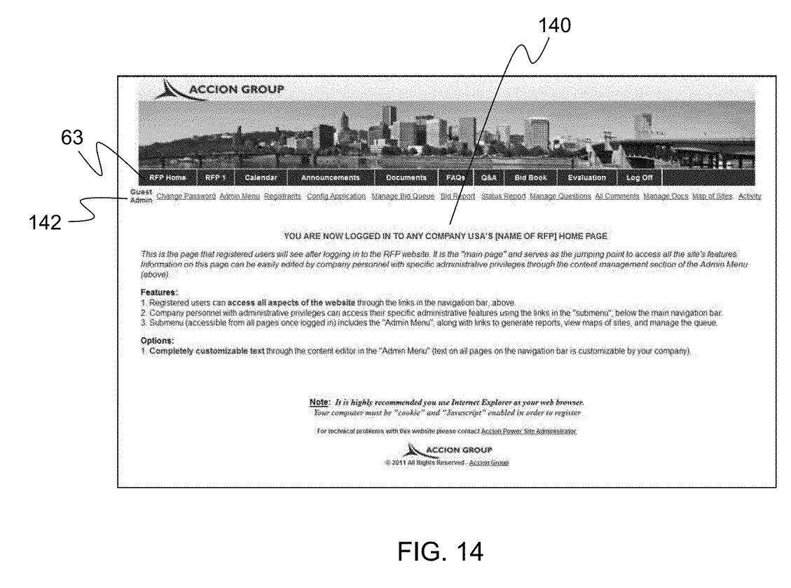

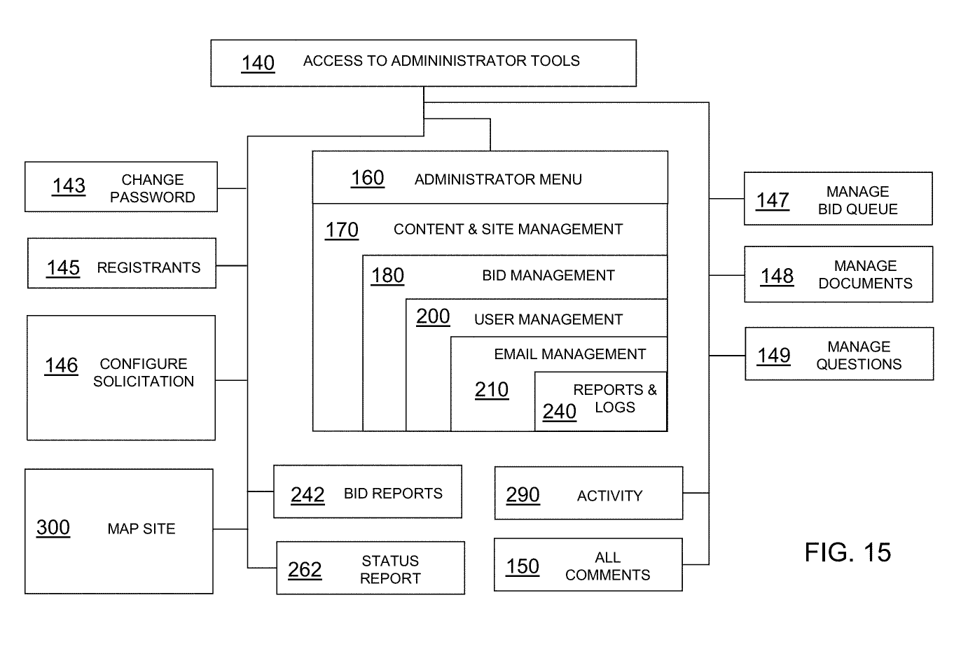

The RFP bid form 37 and each module is configured specifically for each RFP through an administrator module 140 that includes many functions for managing the site content. After logging in as an administrator 30 the administrator navigation toolbar 142 is shown on the RFP bid form 37 providing access to the administrator tools 33. As shown in FIGS. 14 and 15, the administrator navigation toolbar 142 includes for example, access to features to change passwords 143, to access a list of registrants 145, to configure solicitation functions 146, to review and manage the bid queue 147, to manage documents 148, to manage questions 149 and comments 150, and to an administrator menu 160 that supports the configuration of additional features that will be described in further detail below.

Administrative tools such as control of user's passwords and levels of security access that are given to each user in modules 143 and 145 are known in the art. However, the solicitation management system 12 further provides immediate restriction and lockout to users that for example do not meet the prequalification parameters or that overburden the system by submitting an excessive number of bids. The system 12 further includes anti-hacking protocols that detect data entries and document uploads that are coded for hacking. These administrative tools further restrict user access to a single login username and password for each company profile restricting access per company to one registered bidder 77, in this way the responsibility for any data or document posted to the system 12 is held by the one listed user of that facility, limiting control and focusing disputes with the solicitor to a single individual. Further control is maintained over the default registry security settings and access settings, e-mail and login setup of each user and other security features to secure and protect confidential information supplied by both the solicitor and the bidders. Data replication and redundancy is performed automatically on all data to prevent the loss of data and all servers are secured in optimal conditions.

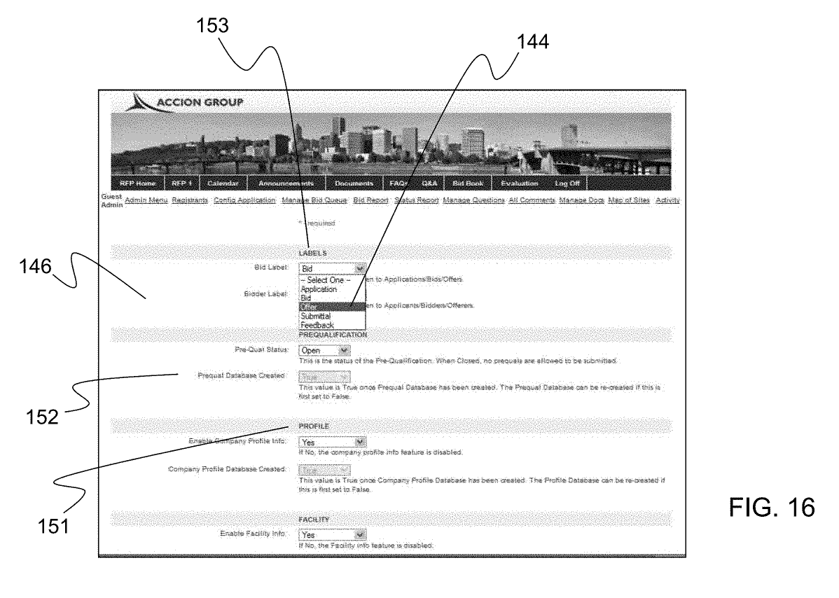

The configure solicitation module 146 allows the administrator 30 to configure control settings which determine how the site and system behave, for example enabling and disabling certain modules and determining when the modules are visible, and to whom. Through a series of display sections 152, as shown in FIG. 16, the administrator 30 selects the appropriate text, sections and information that will be displayed throughout the bid form 37. A series of pull down menus 153 and/or radio buttons 135 are provided to select qualification parameters for display in each section that are shown as section headers 151 in FIG. 16. For example, to configure the solicitation system 12 for a specific solicitation, the administrator 30 must enter the appropriate sections for the utility power requirements of power that it needs to supply to its customers. In entering these requirements, each solicitor may have very specific terminology within their industry, or within their company and conformity to this terminology is important to allow new solicitations to be matched and standardized with prior solicitations. Using the configure solicitation module 146, the application software 17 is configured to provide data structures, metadata and attributes for each data field that at a higher level support the overall functional requirements of the solicitation. In this way a global execution of commands to configure an attribute or perform other modifications to a data field and other feature within the database may be implemented. Through this implementation, each term within the database may have a label attribute attached to every identification data field within the database. Using this label attribute, selected terms may be presented in the label section 153 in the configure solicitation module 146 and using a pull-down menu 144 every instance of the selected term within the database may be autotransposed by simply selecting a similar, alternative term. In this manner, any word used as an indicator may easily be changed, such as for example, the use of the word BID within the solicitation may easily be changed to OFFER by selecting OFFER within the label section 153 of the configure solicitation module 146. Every instance of the use of the word BID within the database is replaced with the term OFFER customizing the solicitation to the user's preference. This removes a common problem in database design and implementation, where a modification of a single term in a data field in the database breaks or distorts a link that the data field has with other forms or features within the database or external to the database resulting in errors and possible corruption of data.

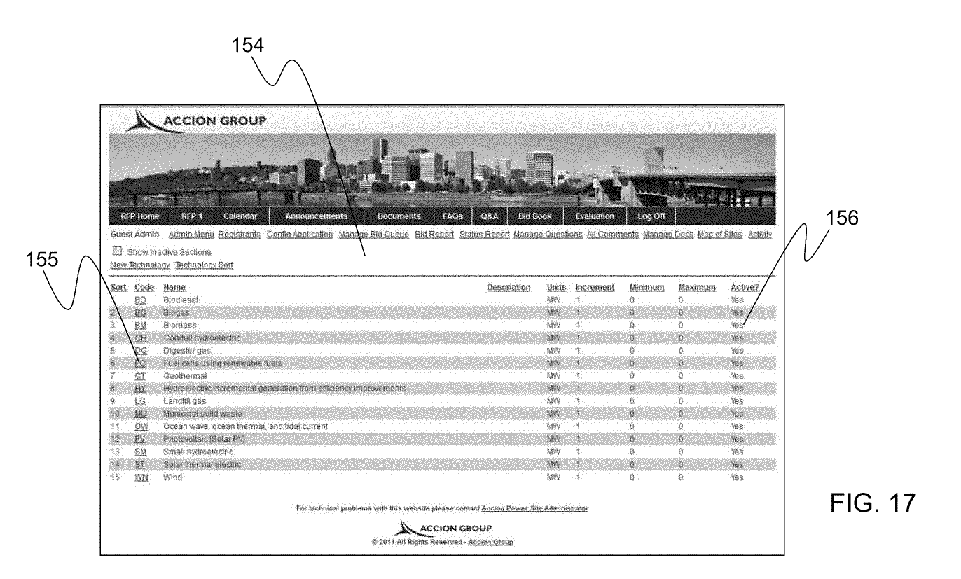

As shown in FIG. 17, a configure technologies function 154 of the configuration solicitation module 146 provides for the selection of customized predetermined technology bid forms using templates 92 and data entry fields that may be configured for each web page display. For example, a specific energy product, such as wind power would have similar requirements from one RFP to the next however the specific terminology regarding those requirements may vary significantly from one RFP to another. By entering the proper terminology and labeling, the same base wind energy product form may be used for multiple RFP's with each form customized to the solicitor's preferences without having to code or compile additional software for this customization, greatly reducing time and code errors that may be introduced in performing a software modification. The configure technology section 154 presents a list of technologies that by selecting the proper code 155 opens an access control form for the power production technology that provides for the inclusion of the specific technology form template associated with the technology, such as a wind power form template that provides for submission of bids from wind power energy producers. Activation 156 of the selected technologies within the bid form 37 is shown on the configure technology section 154. The ability to add additional description and requirements for a power technology within a technology template form and other display settings may also be modified using the configure solicitation module 146. The preconfigured templates, display settings, and auto-transposition features greatly reduce the time to configure an RFP for solicitation and provide the customization required by the utility company to meet their solicitation standards.

The configure solicitation module 146 also enables the administrator 30 to set other parameters for the solicitation such as prequalification and qualification parameters, company profile, desired technology and product parameters, bid, pricing and display options to customize the site and electronic bid application form according to client, i.e. utility, preferences. The configure solicitation module 146 also provides for the selection of pre-qualification form templates and other information that will be displayed prior to the solicitation becoming active, showing what the specific requirements for prequalification may be. For example, form templates may require an interested energy producer 16 to enter personal information on the bidder and basic location and ownership information on the energy producing facility. The configure solicitation module 146 may also be used to determine what general information may be displayed to the public during the period of solicitation. This information would not include access to any information about or from the current registered bidders 77.

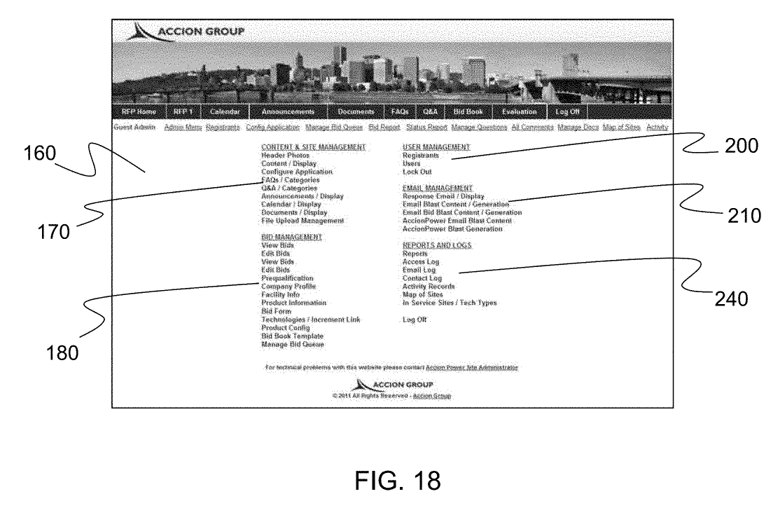

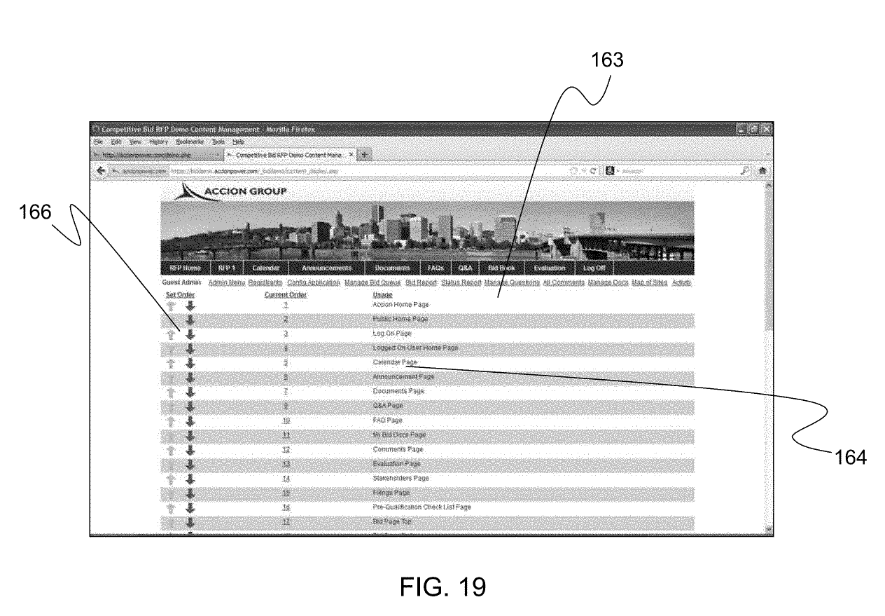

The administrator menu 160 as shown in FIG. 18 provides access to content and site management features 170 that control the display of the company logo 39, company picture 41 and/or the RFP graphic 49 and other general layout and formatting of the menus on the home pages. For example, templates may be selected to change the overall layout of headers and data fields displayed within each web page. A company image may be selected to display on the title page using the header photos function to select and upload banner photos and site graphics for quick customization of the solicitation website landing page. A content display function 163 shown in a first embodiment in FIG. 19 enables the administrator 30 to modify all static site content such as instructions, descriptions of the solicitation, and other information. The terminology and display of each data entry field may be customized and/or turned on and off based on the solicitation requirements. Further features include dialog boxes where general information, instruction or external document links may be typed in for display on the home page or other pages within the solicitation or company website. The order and display of each web page may also be adjusted using the content display function 163. A list of each webpage 164 and placement arrows 166 provide for adjustment of the order of forms and templates that are displayed as the registered bidder 77 moves through to complete the bid.

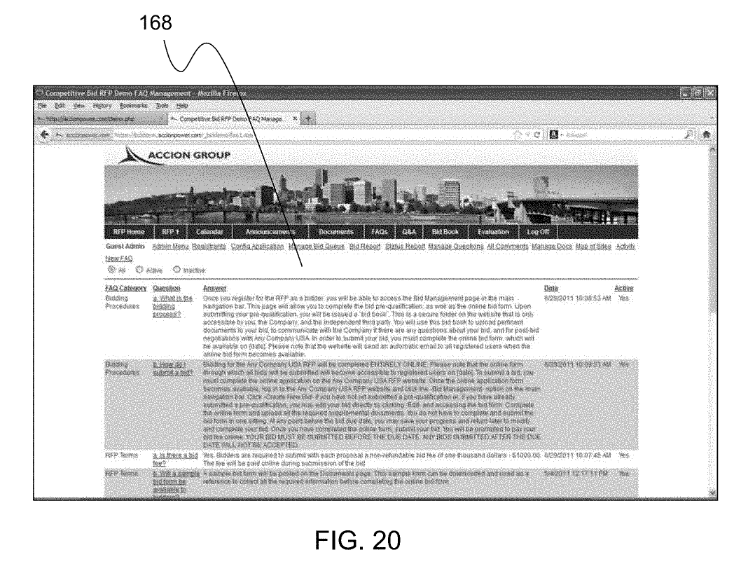

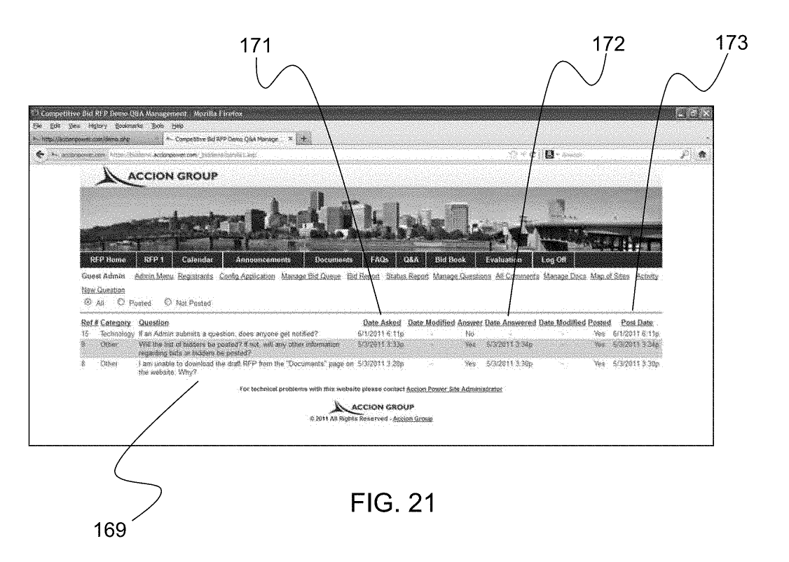

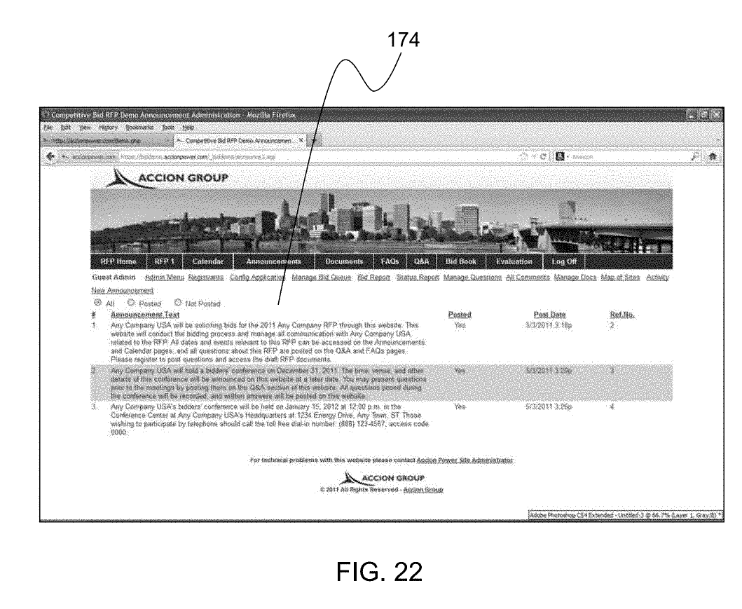

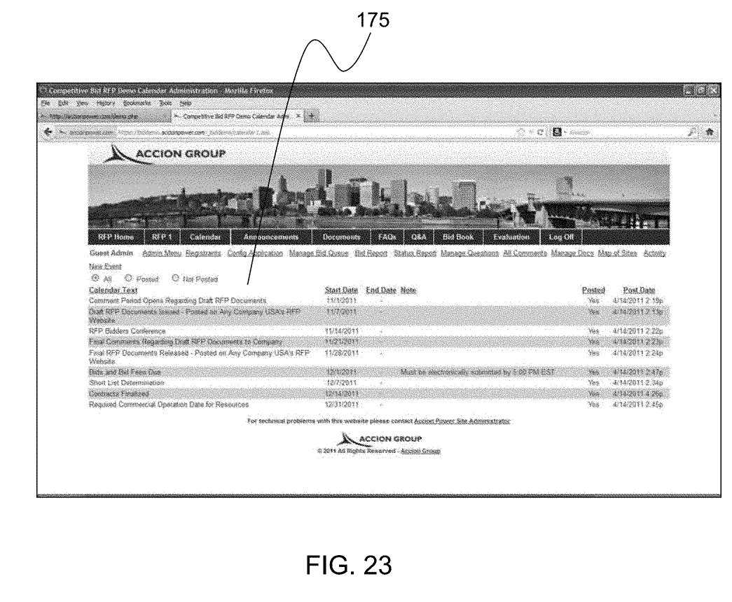

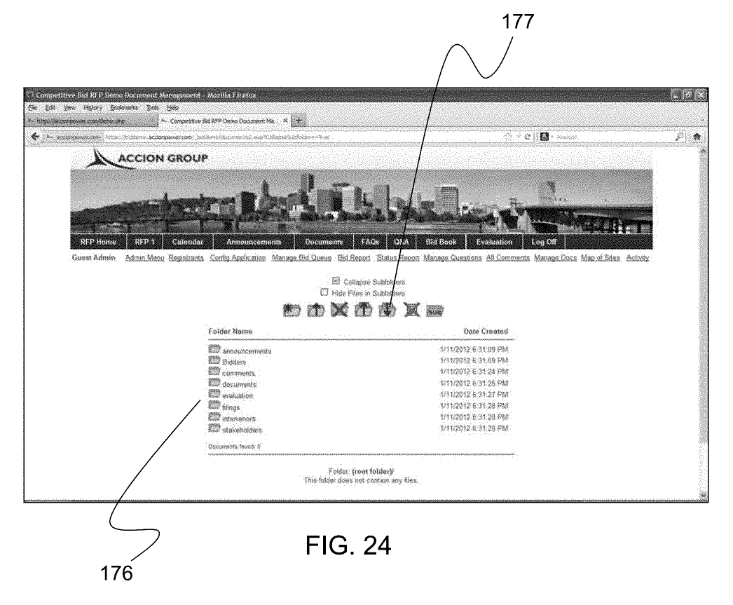

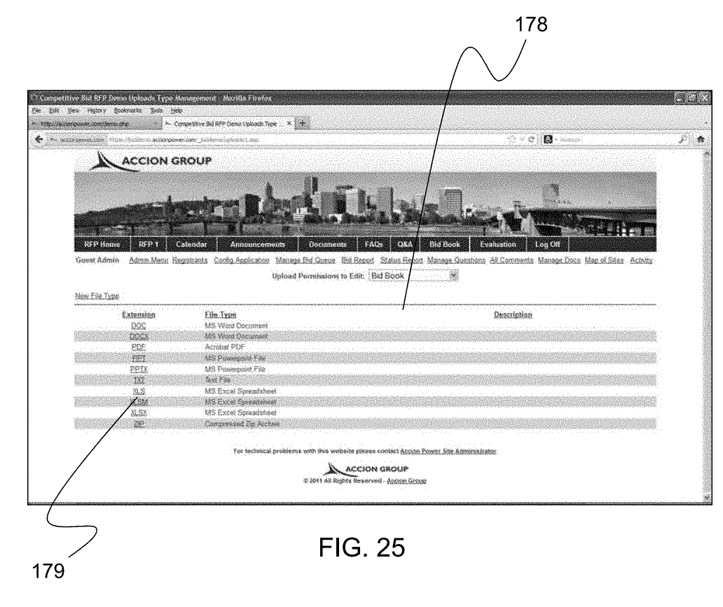

As shown in FIG. 20, a facts module 168, i.e. FAQs/categories enable the administrator 30 to post frequently asked questions and facts regarding the solicitation. A question and answer module 169, shown in FIG. 21, provides for posting of questions by bidders and users regarding the solicitation as well as answers from the administrator or utility for public viewing. Using the administration tools 33, audit information on the date asked 171, date answered 172 and the date posted 173 is also shown. An announcement/display module 174 allows the utility through the administrator 30 to post, remove and edit critical announcements that are important to any solicitation or a number of solicitations as shown in FIG. 22. Access to a calendar/display module 175 provides for the management of the solicitation timeline and calendar which can be displayed to bidders 77 and users with respect to the solicitation as shown in FIG. 23. Critical dates for submission of specific information and open and close date of the solicitation is provided within this module 175. A document display module 176, shown in FIG. 24, provides for document management and access to documents for a solicitation reviewer 83 providing for documents to be displayed and copied for review. Folder access and management icons 177 allow the administrator 30 to create, move or copy folders and or subfolders that are globally displayed and utilized for the upload of documents from each registered bidder 77. As previously described, documents naming, and file location are consistent between each bidder, removing the necessity for manual organization of documents to prepare a set of documents for review. A further feature of the content and site management function 170 is the file upload management function 178 as shown in FIG. 25 that controls the compatibility of file formats that may be uploaded to the solicitation management system 12. The administrator 30 may add file formats 179, such as word documents, portable document format (PDF) or others as required.

The administrator menu 160 also provides access to the bid management module 180 such as access for the administrator 30 to view all bids, setup data entry fields for the information required under the company profile for each registered bidder 77, and configure the prequalification form template. The prequalification function enables the administrator 30 to set and control the parameters for who may be accepted to bid on the solicitation. The prequalification may include a main section and subsection details that can be configured and previewed from this location. A company profile function includes a form having sections, subsections and certain details and instructions which can be configured and previewed in this location once the profile is configured by the administrator 30. A product information function includes sections and subsection details that can be configured and previewed from this location. Once the prequalification, company profile and products information forms are configured, a bid form database and domain may be configured and interested bidders may submit their prequalification information.

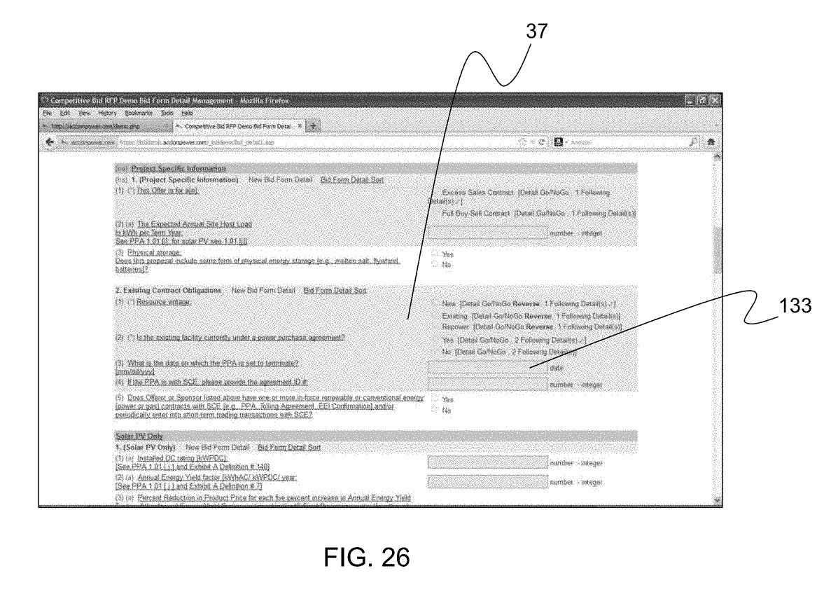

The bid management module 180 also provides access to configure each data entry field of the bid form 37 a section of which is shown in FIG. 26. Prior to activation of the solicitation, preset bid form templates 92 that provide general requirements for product procurement may easily be tailored to product and solicitation specific requirements by modifying one or more identification labels for each data entry field 133. Data entry fields 133 may further be ordered and displayed in sections and subsections within each bid form 37 and the order of the bid form sections and subsections may be further configured. Using the bid management module 180, general information such as the entry of contact and location information and subsections that include feature specific details such as energy production requirements and site details provides for broad global changes to terminology to data fields that are used throughout the solicitation as described above, or local changes to subsection templates that may be prepared and integrated into a higher level template within broader sections of the solicitation. In this way critical, detailed information specific to a certain type of requirement in a solicitation may be created as a subsection template further tailoring the bid form to the company's specific requirements.

The use of templates, sections, subsections and preset data entry fields are important features of the present invention in the configuration and modification of the bid form 37. Using these features, the layout and display of each web page may be completed without additional coding or scripting of the database and without requirements of recompiling software or the database for these modifications. After completion of the layout and data entry fields for each web page, access to any modifications of the application software and database is closed and secured. The solicitation is then activated to accept bids, and all contact information, data entry, all communications, and all other transactions of the solicitation are tracked and recorded. Any modification to the solicitation after activation requires the deletion of a current RFP and the creation of a new RFP within the system and setting up a new domain location. Inactivating an RFP prior to a scheduled close date due to error or the presentation of incorrect information, requires the restart of the complete solicitation process with the requirement that all entered bid submissions be reentered. In this way, uniformity and the consistency of information presented to all bidders is maintained, a requirement for fair and unbiased solicitations. The procurement management system 12 further provides for many stages of review by the solicitor 83 prior to activation to avoid any scenario that would require an unscheduled shutdown due to the presentation of inaccurate or incomplete information.

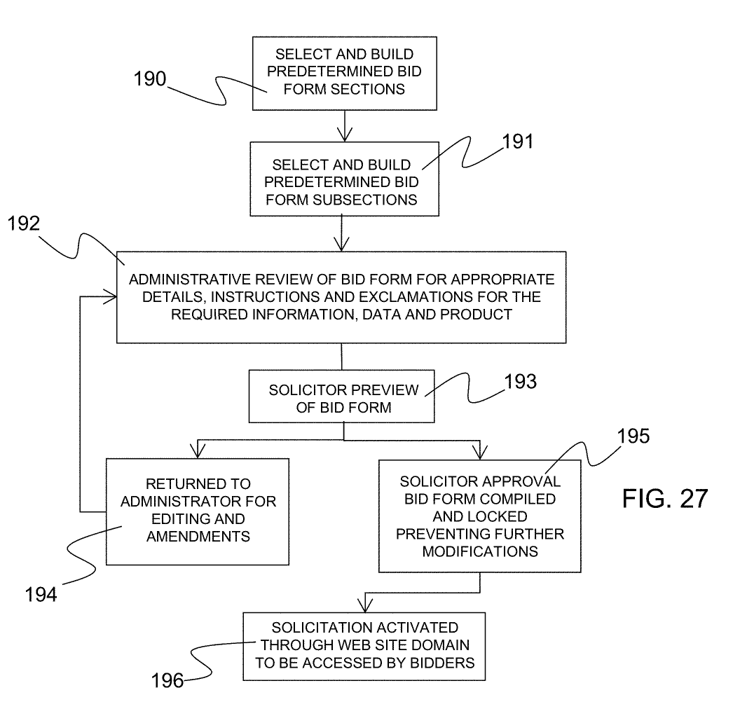

As shown in FIG. 27, the customized bid form 37 allows the administrator 30 to in a first step 190 select and build the desired and predetermined bid form sections. In a second step 191, the bid form subsections can be selected and built as well. A third step 192 provides for the administrator 30 to ensure that the appropriate bid form details are entered on the bid form such as instructions and exclamations for the required information, data and product. In a fourth step 193 the form is presented to the solicitor 83 to preview and in a further step 194 is returned to the administrator 30 to be edited and amended as required. In a fifth step 195 the solicitation may be compiled and locked preventing further modifications and in a final step 196 the solicitation may be activated through a web site domain and be accessed for prequalification by bidders.

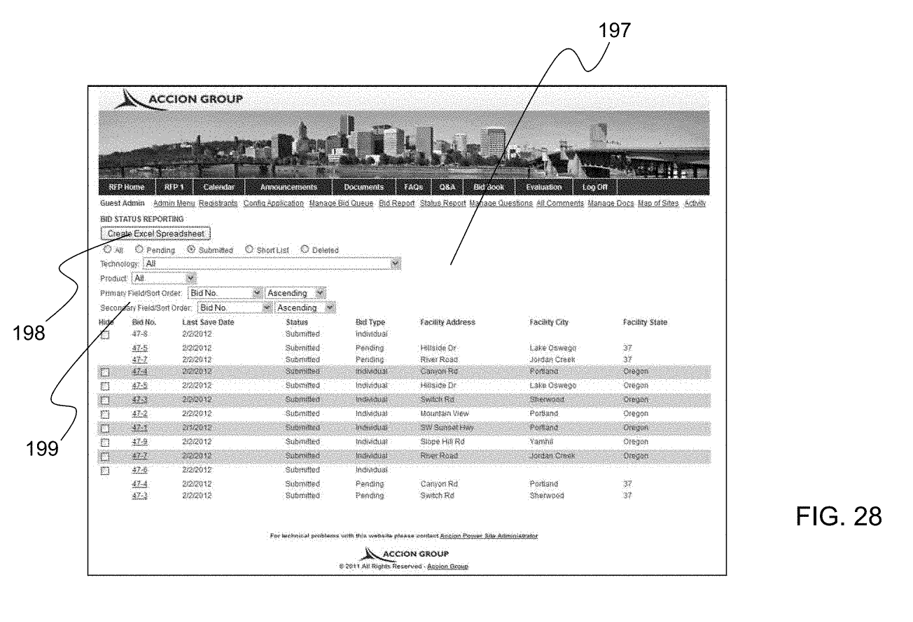

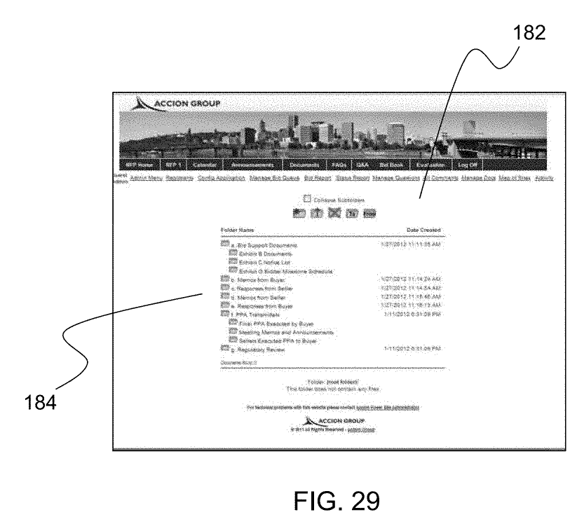

A view bids function 197 gives the administrator 30 the ability to view pending, submitted and deleted bids. The function 198 includes sorting tools 199 and export controls to export all or a portion of the bids to an Excel spreadsheet as shown in FIG. 28. The bid management module 180 also provides access to the bid book template 182 that structures the submission of documents uploaded from registered bidders 77. As noted above, an inordinate amount of time is spent by solicitor reviewers 83 organizing and collating uploaded documents. The bid book module 182, as shown in FIG. 29, provides for the administrator 30 to define a file folder structure 184 that restricts the upload of any document to a directory structure and location specified within the bid form 37. The application software 17 further accesses the file in the appropriate folder and renames the file based on the defined naming structure of the bid book module 182 and the type of file being uploaded, creating uniformity in file naming between bidders 77 and direct access to required information by a reviewer to more easily compare document uploaded by a first bidder, to the same requirements documents uploaded by a second bidder.

The bid management module 180 provides other features that assist m configuring technology, capacity requirements and other detailed requirements that are necessary for the solicitor reviewers 83 to properly evaluate each bid submission 85. Further features include a technologies increment function that provides for the selection of a failed bid being linked to a specific technology if increment values are required. Using the entered values within the prescribed qualification ranges and the specific technology templates, bid submission data may be ranked based on a selection by a reviewer of data entry labels to select and display only those energy producers that meet the selected criteria of interest. A reviewer may select one or more data entry fields of interest and bid submissions having the highest and/or lowest values within the specific criteria selected would be displayed in order of their ranking, for example, base load, peaking and non-peaking power production values, and the cost per kilowatt/hour may be displayed to quickly determine and select only energy producers of the highest ranking and thereby filter out other energy producers.

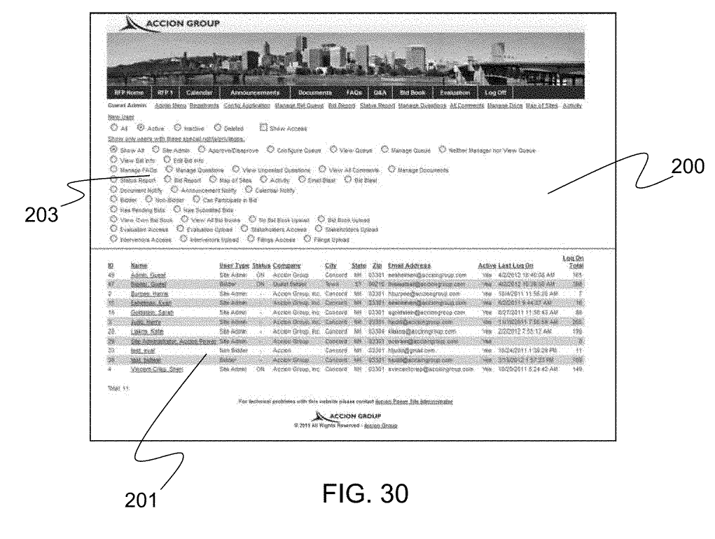

The administrator menu 160 also includes a user management module 200 that allows the administrator 30 to access attributes of pending, approved and disapproved such as their contact information and date of registration. If registrant approval is configured as manual, registrants can be managed via this function. Alternatively, a user module 201 may be used to have the administrator 30 add, edit and manage all user level access rights, security permissions and notification settings. A set of radio buttons 203 may be used to define access rights and privileges for a user to perform functions such as modify a bid form, enter FAQ's, respond to questions and access bidder documents, and access may be allowed or denied prior to or following activation of the bid form 37 as shown in FIG. 30. Access to any request for information in the bid forms 37 will be restricted by the administrator 30 to allow modifications only prior to activation. A lock-out function that permits management of users restricted from access to the bid form 37 for violations or SQL injection incidents can be managed from this location.

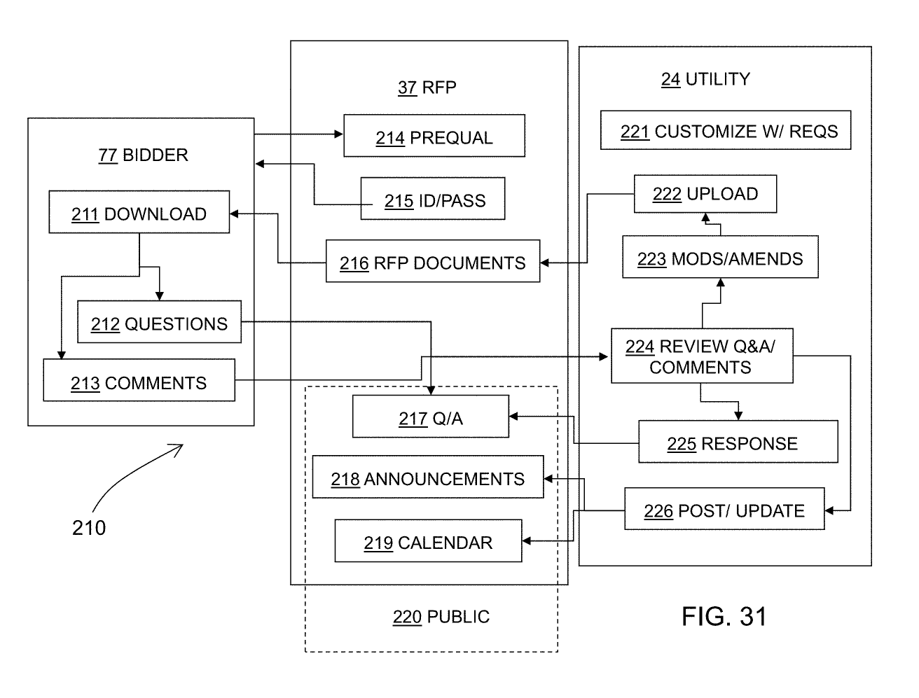

A critical component of the solicitation management system 12 is the email management module 210 that provides for both anonymous and direct communication to and from any bidder, reviewer or administrator 30 within the bid form database. The module provides for restrictions to prevent the identity of a bidder from a reviewer in communicating a question or comment. The email module 210 further provides for global or blast emails to every user, to only users that have submitted bids or to other subsets of users, again providing for the same information to be provided to all users at the same time. A diagrammatic representation of the communications system and networks that the email management module 210 must encompass is shown in FIG. 31. A registered bidder 77 or unregistered bidder user may download RFP documents 216 and other information as indicated by 211. The documents may create questions 212 or comments 213 from the user. The questions and comments are directed to a reviewer 224 of the utility company 24 or other solicitor and a response 225 may be posted to the Q & A page at 217.

Alternatively, a blast email responding to a question may be sent to all registered users 77, depending on the information that must be communicated. The response 225 may further result in an amendment 223 to instructions or other RFP documents 216 that may be uploaded 222 to further explain the content and requirements of the RFP. The question or important new information may also be posted 226 to an announcement 218 or calendar 219 if there are changes to the schedule or critical new information must be distributed. The post may be distributed privately to registrants 77 or to the public 220. The criteria for each distribution are configured through the email messaging module 210.

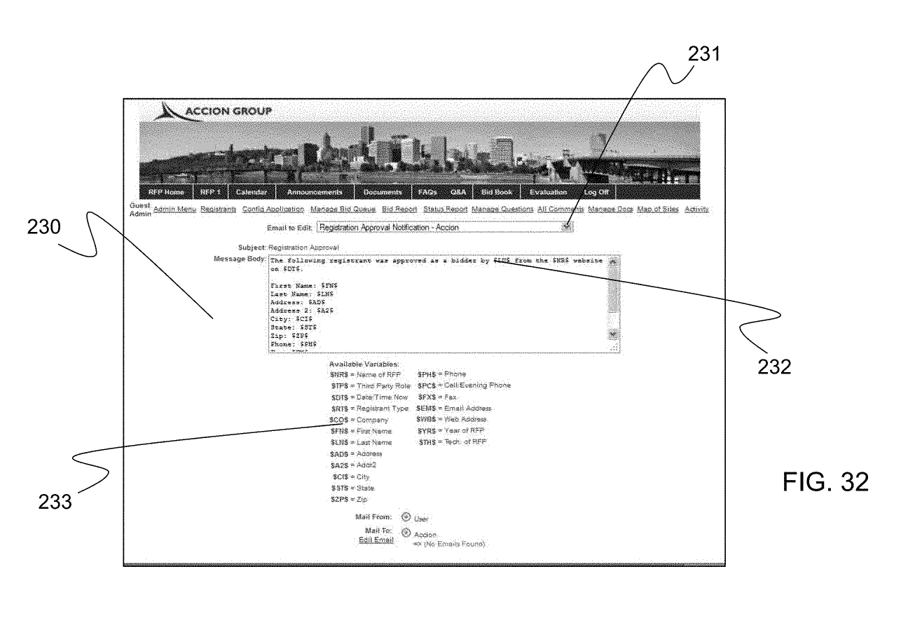

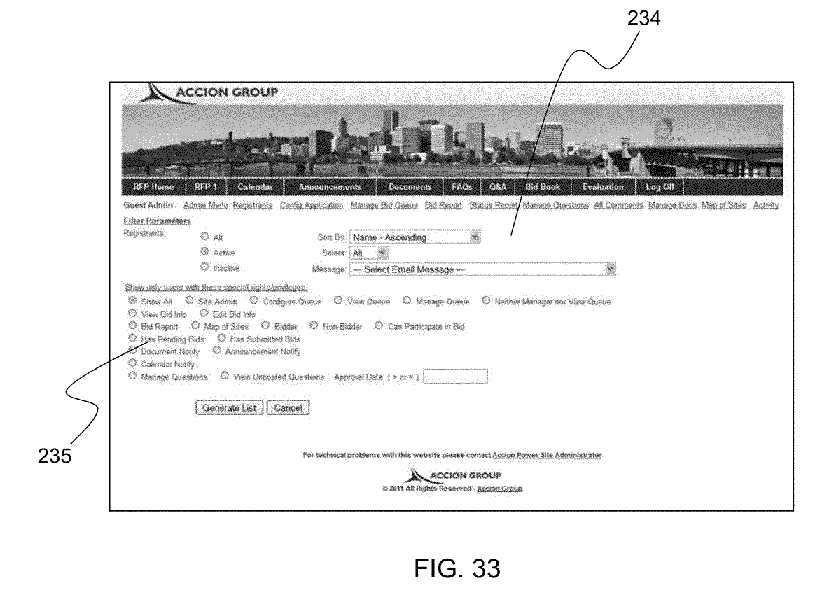

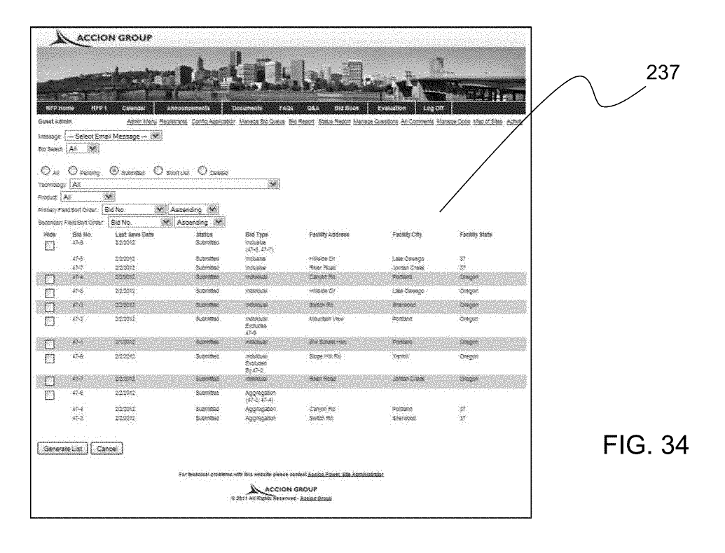

The email messaging module 210 includes a message generator 26 and a notification generator 29. The message generator 26 provides for automated emails to be generated for the appropriate parties whenever a new posting is made to the bid management form. The notification generator 29 can be set to trigger on the posting of new information in the RFP and automatically distribute notification message of the new posting. The automated message may simply be a new posting, requiring the user to login to the system 12 to review the posting, thereby maintaining security of information within the database. For example, a notification message stating simply “Post to Q & A” may be generated and distributed when an answer from the reviewer 83 or administrator 30 is posted for a question submitted from a bidder. As shown in FIG. 32, access to email response templates 230 are provided within the module, to reduce time in writing an email for a repetitive notification. A pull-down menu 231 provides a list of optional emails that may be selected that include preconfigured email text 232 and variables 233 to include identifying information of each user receiving the email. The variables 233 are tied to data attributes of contact information, an email address and other information of all the users of the system 12. The inclusion of variables 233 within the email provides for an email to be constructed and delivered to preconfigured distribution lists, without the sender or receiver becoming aware of the identity of anyone on the distribution list. Other features provide for the creation of content for new emails, the generation of blast or global emails, or emails to be sent to or from the administrator 30 to select distribution groups. The distribution module 234 may be configured to create lists using radio buttons 235 of user attributes to restrict emails to a certain set of users, such as those users that have special rights and privileges to view for example a bid report or map of a site as shown in FIG. 33. Alternatively, the bid number list 237 may be used to select any one or all bidders to receive an email notification or further bid information as shown in FIG. 34.

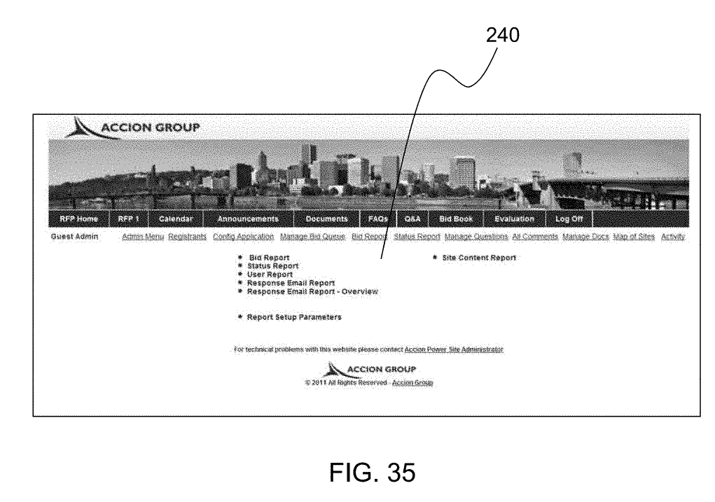

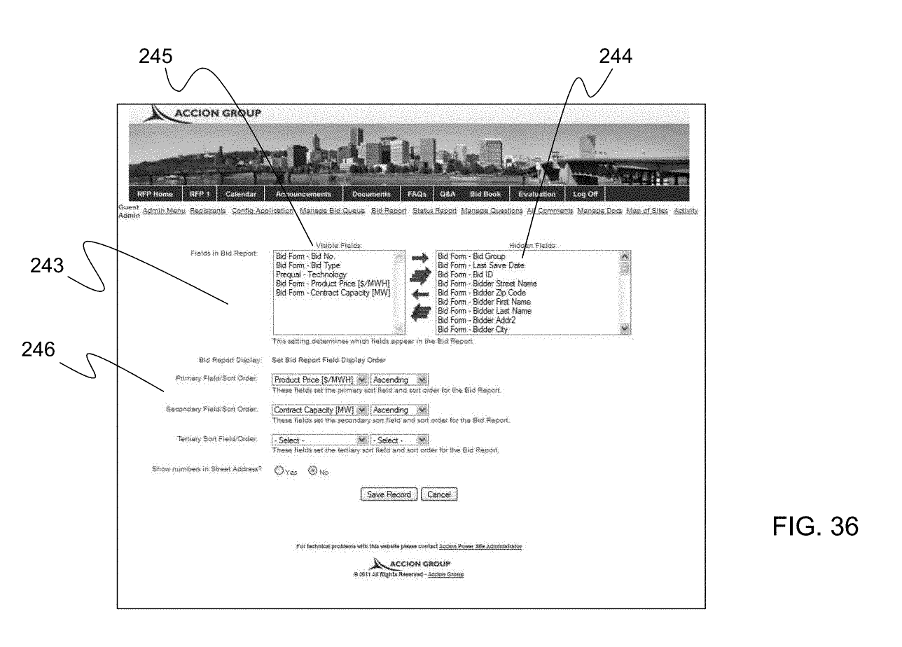

As shown in FIG. 35, the reports/logs access portal 240 provides bid, status as well as user and email related reports. In a first embodiment a report may be configured by selecting data field headings to form columns. The data fields are from those used in any bid form, prequalification form, company profile or facility entry that have been defined within the database. In a bid report 242, the configure bid report layout 243, as shown in FIG. 36, is used to select for example the bid number, bid type, technology, product price and capacity from a list of hidden data field entries 244 to be placed in a list of visible field entries 245. A sort feature 246 provides for a primary column heading to be used as a first value to sort the report in either ascending or descending order. Secondary and tertiary column headings may also be selected to provide a second or third level of sorting the data, respectfully. As an example, a bid report 242 may provide a list all bids in ascending order with the lowest price bid as the primary filter and capacity as a secondary filter, the bid having the lowest price per megawatt hour with the largest capacity is placed at the top of the report. Other information from any data field such as permit approval, the interconnection points to the power grid and interconnection voltage or other information may be easily selected to configure a report specific to be used by a reviewer 83 for direct comparison of all or any number of bids based on the selected criteria.

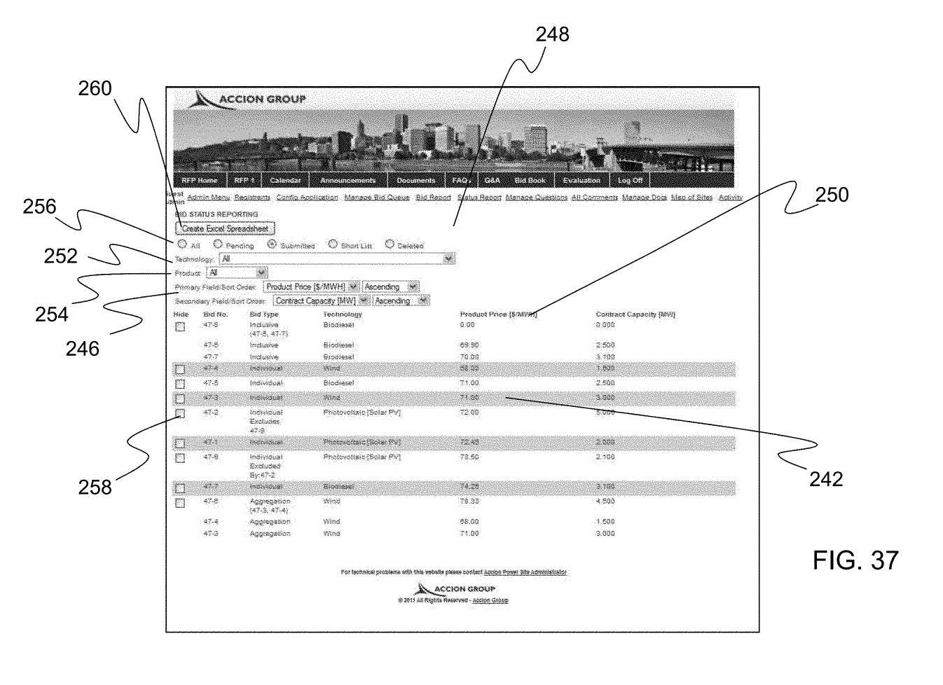

By closing the configure bid report layout 243 and selecting generate bid report 248, as shown in FIG. 37, the selected column headings 250 in the proper ascending order are displayed. A sort feature 246 like the configure bid report feature provides for sorting the report 242 by any column heading, with both the primary and secondary filter displayed. A technology filter 252 provides for selection of bids of only one type of energy source such as the option to display only bids using for example geothermal as the power source. The product filter 254 provides for the report 242 capacity to further be sorted by base load, peaking and non-peaking values. A selection filter 256 provides for all bids to be viewed, or only those pending, submitted, deleted or those previously selected on a short list to be viewed. A hide filter 258 allows a reviewer to further reduce the list by hiding any bids that are selected. An important further feature is the export function 260 that exports of all data from the report into an external spreadsheet format that may be further manipulated or copied to use in other reporting formats.

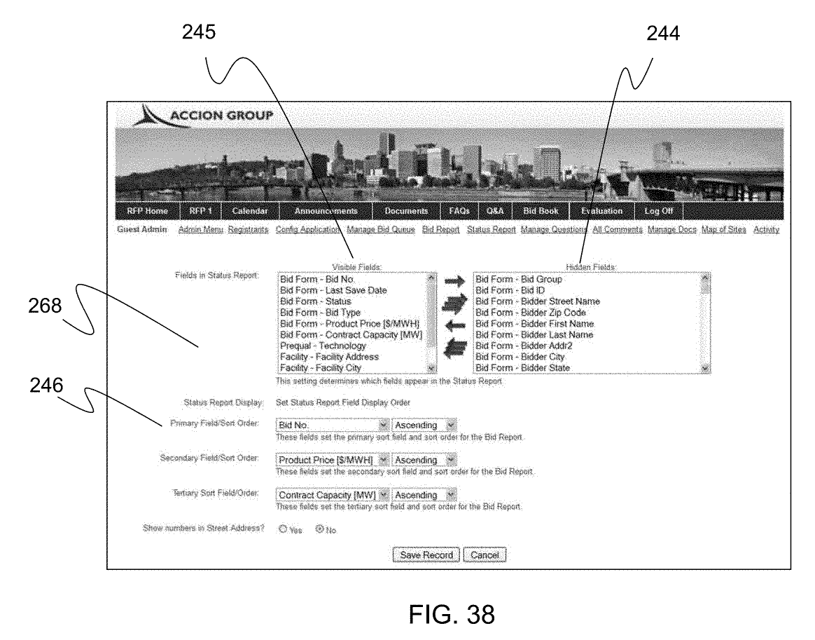

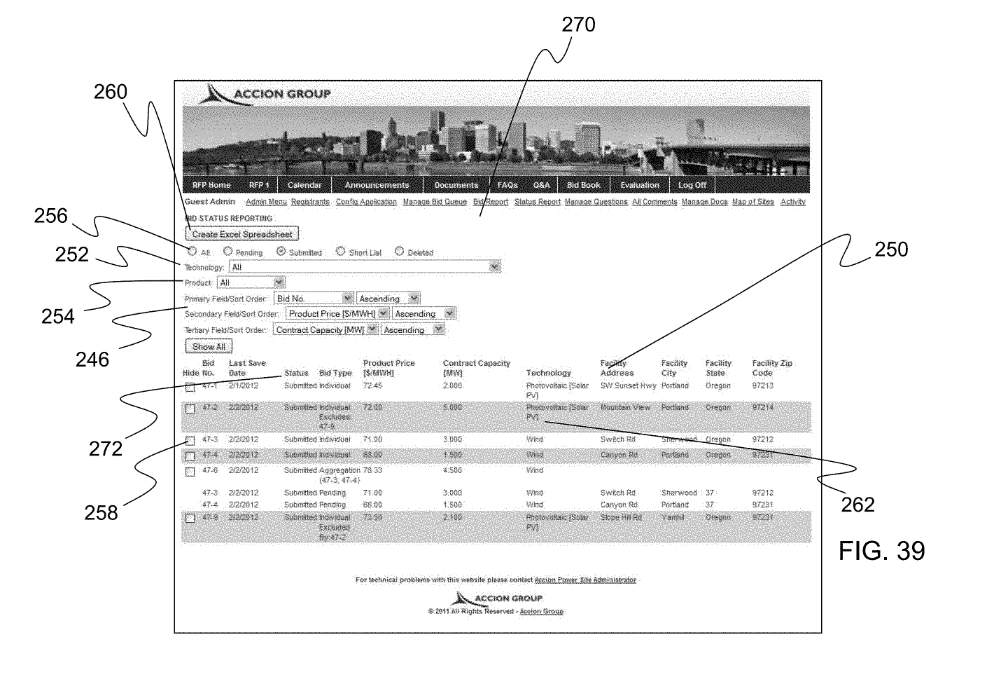

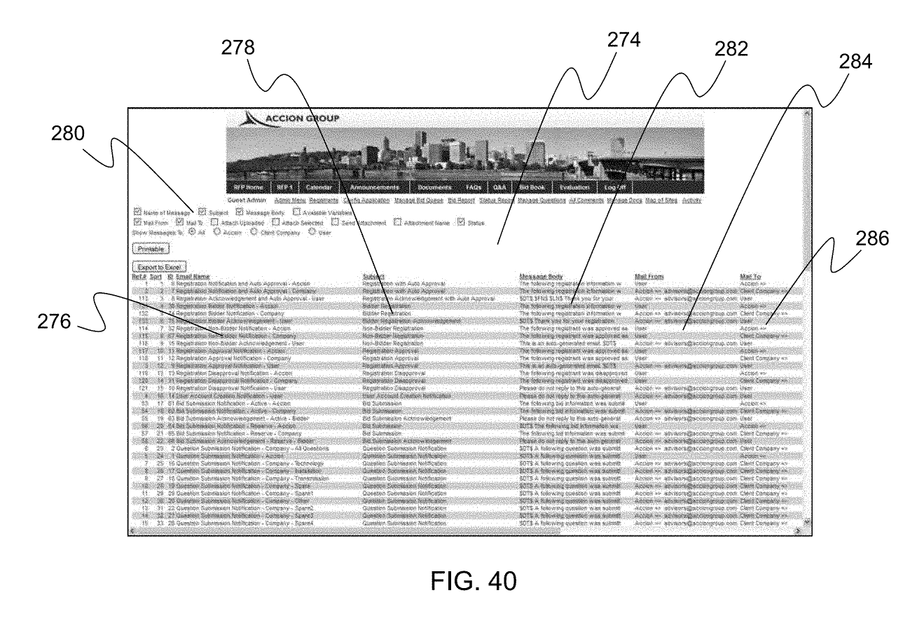

A status report 262 may be generated by selecting data field headings in the configure status report layout 268 as shown in FIG. 38. Similar, selection of all data fields from a hidden list 244 to a visible list 245 and sorting features 246 as described above are used to configure the status report 262. The status report generator 270 as shown in FIG. 39 displays the configured report 262 with similar filtering and export features as described above. A status field heading 272 provides the status of all bids selected within a report. Other examples of reports in a first embodiment of the present invention are a user report that displays the access permission rights and privileges as well as distribution list affiliation for every user of the system 12 or a response email report 274 as shown in FIG. 40 that displays every email message communicated between the administrator 30 and bidders 77 or the reviewer 83 and bidders 77. The report 274 lists every message by name 276 and subject 278 and display buttons 280 may be selected to view further information such as the message content 282 and the sender 284 and receiver 286. A site content report may also be generated to review for clarity all information and instruction provided throughout the solicitation to assist bidders in completing the bid submission. The reports and logs module 240 includes further features to setup the parameters of each report.

Other features within the module 240 provide audit control and tracking of all transactions by all bidders 77 or a select set of bidders or users within the system. As an example, an access log function enables review of transactions and includes the date, time internet protocol (IP) address the action taken and the web pages accessed. The email log provides email review and displays all emails sent or received up to and including a selected day, and as many days prior to that date as selected with date and time stamps of every message. A contact log may provide information from contact form submissions of each user including registered and rejected bidders for review by the administrator 30 and reviewer 83. Activity record reports 290 enables the review of bid related activity up to and including a selected day, and as many days prior to that date as selected with date and time stamps. Access to these and other features may be through both the administrator navigation toolbar 142, through features within the administration menu 160 or through other access points. Other features include lists of registered bidders 145 and the time of bid submissions in a manage bid queue application 147. A further manage documents module 148 provides access to information such as regulatory information or instructions on using the bid submission website or other information that was posted by the administrator 30 in setting up the solicitation. Other features and templates may be configured to particularly accommodate the type of product procurement or industry, such as military procurement, educational procurement, grant proposals for medical research and others that are contemplated within the scope of the present invention.

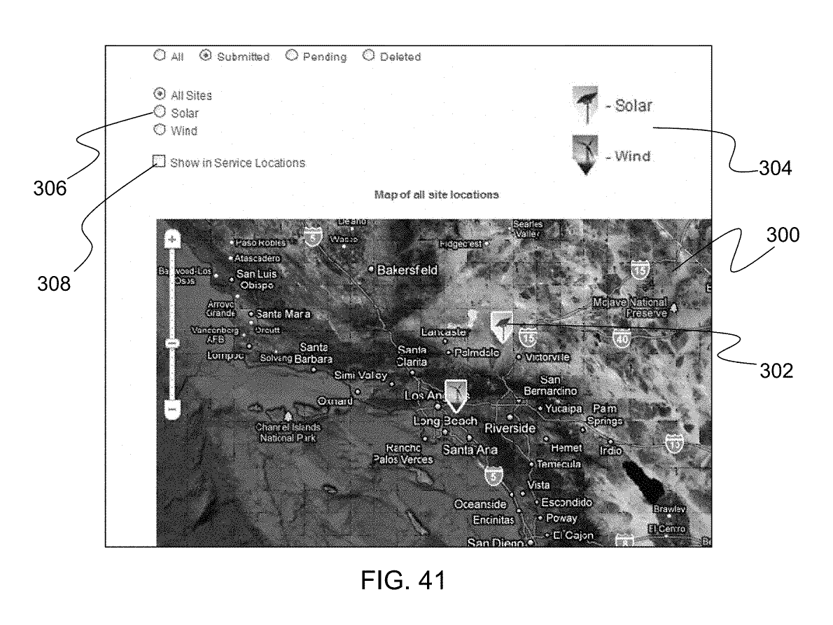

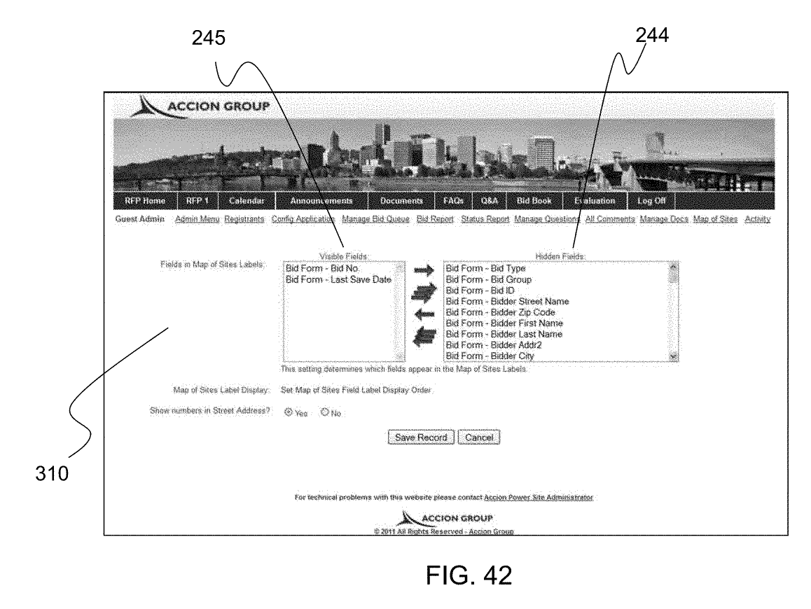

A map site function 300 as described above provides that prequalified users and registered bidders 77 denote their energy production facility location as part of the bid submission and the location of those facilities can be superimposed and viewed on a map by a reviewer 83 as shown in FIG. 41. Color coded or graphical icons 302 may be selected to denote bidder 77 locations and type of energy production facility. A legend 304 provides information on each overlay feature. An overlay selector 306 using radio buttons can select which icons or overlays will be displayed. A further selector 308 may provide currently active energy production facilities. A configure map of sites label function 310 can add label overlays to the map by selecting from hidden data field headings 244 and moving the headings to visible fields 254 as described above and shown in FIG. 42. The solicitation management system 12 further provides options to generate maps and geographic information of existing in-service facilities with technology type and other information to assist a reviewer in adequately determining a bidder's location with respect to pre-existing facilities to properly provide coverage in a solicitation region.

The invention has been described in detail with particular reference to certain preferred embodiments thereof, but it will be understood that variations and modifications can be affected within the spirit and scope of the invention.

What is claimed is:

1. A non-transitory computer-readable media including computer instructions for implementing a strategic energy selection system to meet capacity for an electric generating plant, comprising:
electronic processing systems implemented on digital devices, the digital devices having a computer processors, memory, and data storage;
the electronic processing systems comprising instructions for configuring an authentication interface accessible to one or more isolated data structures;
the electronic processing systems communicatively coupled to a user interface and the electronic processing systems and user interface operable and comprising application software to implement instructions that receive, transform, transmit and display transactional data related to power supply requirements for an electric generating plant, the application software implemented on at least one database installed on a computer system having an internet connection accessible through the authentication interface; and
comprising instructions of:
receiving specifications related to the power supply requirements of an electric generating plant, the power supply requirements comprising capacity requirements and a plurality of energy products;
receiving capacity and a type of a plurality of energy products from a plurality of energy producers;
activating a set of data fields related to one type of the plurality of energy products by implementing a configure technologies function of a configure solicitation module to configure data entry fields based on capacity and type of energy product received from one of the plurality of energy producers;
verifying the capacity of each energy producer is within the capacity requirements of the electric generating plant; and
denying access to the solicitation module to each energy producer having capacity outside of the capacity requirements;
generating a plurality of qualification parameters related to the production of energy, each qualification parameter having a range and threshold based on requirements from the electric generating plant;
receiving qualification parameter data from each of the plurality of energy producers that have capacity within the capacity requirements;
generating a plurality of bid submission forms with each form comprising a plurality of qualification parameters specific to only one type of the plurality of energy products;
displaying to one of the plurality of energy producers a bid submission form specific to the type of energy product of the energy producers thereby removing the requirement to enter qualification parameters that are not applicable to the energy producer; and
selecting one of the plurality of qualification parameters as primary;
selecting one of the plurality of qualification parameters as secondary;
determining the value of each qualification parameter for each of the plurality of energy producers;
filtering to display only energy producers that have the selected primary and secondary qualification parameters;
ranking the energy producers by the value of the primary and secondary qualification parameters; and
selecting an energy producer to supply energy to the electric generating plant based on their ranking.

2. The non-transitory computer-readable media including computer instructions for implementing a strategic energy selection system of claim 1 wherein the isolated data structure prevents cross storing of data related to a specific energy producer;
generating a map site interface from qualification parameters of one of the plurality of energy producers;
generating a document management module that defines a file folder structure to restrict uploaded documents provided from a specific energy producer to a directory structure and location specified within the bid submission form;
configuring an electronic messaging module having an email management module, a distribution module configuring user attributes, a message generator and a notification generator
distributing messages anonymously from the energy producers to electric generating plant.

3. The non-transitory computer-readable media including computer instructions for implementing a strategic energy selection system of claim 1 wherein the configure solicitation module constructs alternative terms as label attributes for a plurality of data entry fields within a database;
the plurality of data fields configured to be autotransposable by selecting the alternative term label attribute to provide for every instance of a selected word to be changed to the alternative term in all of the plurality of data fields.

4. The non-transitory computer-readable media including computer instructions for implementing a strategic energy selection system of claim 1 wherein the range and threshold requirements are specific to the products and technologies of an energy producer.

5. The non-transitory computer-readable media including computer instructions for implementing a strategic energy selection system of claim 2 wherein the pre-qualification requirements have restrictive data entry fields to prevent access to specific energy producers that do not meet bid pre-qualification parameters.

6. The non-transitory computer-readable media including computer instructions for implementing a strategic energy selection system of claim 1 wherein the map interface displays location information related to each specific energy producer.

7. The non-transitory computer-readable media including computer instructions for implementing a strategic energy selection system of claim 1 wherein data related to a specific energy producer is stored in a confidential bid book.

8. The non-transitory computer-readable media including computer instructions for implementing a strategic energy selection system of claim 7 wherein the document management module stores and identically names uploaded documents in a standardized format specified by the bid submission form, the uploaded documents stored within the confidential bid book.

9. The non-transitory computer-readable media including computer instructions for implementing a strategic energy selection system of claim 1 wherein the electronic messaging module provides anonymous distribution of data and information to all parties.

10. The non-transitory computer-readable media including computer instructions for implementing a strategic energy selection system of claim 1 further comprising at least one of aggregate offers, inclusive offers and exclusive offers.

11. A non-transitory computer-readable media including computer instructions for performing a method of selecting an energy producer to supply electricity to an electric generating plant comprising:
authenticating using a central processing unit (CPU) connected via a network to a remote storage device user accessibility to one or more isolated data structures in a remote memory device;
querying at least one database on a computer system having an internet connection accessible to the isolated data structures to obtain transactional data related to qualification parameters comprising power supply requirements for an electric generating plant, the qualification parameters comprising capacity and technology requirements for different types of a plurality of energy products;
generating an output for the selection of one type of the different types of the plurality of energy products;
querying using the computer system a selection by one specific energy producer from a plurality of energy producers of one type of the plurality of energy products;
compiling using the computer system product and technology data for each of the different types of the plurality of energy products;
constructing using the computer system data entry fields based on the compiled data of the one type of the plurality of energy products selected by the specific energy producer;
generating at least one bid form comprising one of at least prequalification parameters, a plurality of qualification parameters and company profile requirements, and the data entry fields compiled from the products and technology specific to the selection by the energy producer of the one type of the different types of the plurality of energy products; and
wherein the plurality of qualification parameters related to the production of energy, each qualification parameter having a range and threshold based on requirements from the electric generating plant;
displaying visually within a user interface using the computer system the data entry fields specific to the selection of one type of the plurality of energy products by the energy producer;
querying using the computer system data specific to the one type of the plurality of energy products entered into the data entry fields by the specific energy producer;
generating using the computer system a bid submission for the specific energy producer based on the query results, the bid submission comprising the data specific to only the one type of the plurality of energy products thereby removing data that is not applicable to the energy producer;
selecting one of the plurality of qualification parameters as primary;
selecting one of the plurality of qualification parameters as secondary;
determining the value of each qualification parameter for each of the plurality of energy producers;
filtering to display only energy producers that have the selected primary and secondary qualification parameters;
ranking the energy producers by the value of the primary and secondary qualification parameters; and
selecting an energy producer to supply energy to the electric generating plant based on their ranking.

12. The non-transitory computer-readable media including computer instructions for performing a method of selecting an energy producer to supply electricity to an electric generating plant of claim 11 comprising:
storing the bid submission comprising data related to the specific energy producer within an isolated data structure;
receiving prequalification parameters related to the power supply requirements of an electric generating plant, the power supply requirements comprising capacity requirements and a plurality of energy products;
receiving capacity and a type of a plurality of energy products from a plurality of energy producers;
activating a set of data fields related to one type of the plurality of energy products by implementing a configure technologies function of a configure solicitation module to configure data entry fields based on capacity and type of energy product received from one of the plurality of energy producers;
verifying the capacity of each energy producer is within the capacity requirements of the electric generating plant; and
denying access to the solicitation module to each energy producer having capacity outside of the capacity requirements.

13. The non-transitory computer-readable media including computer instructions for performing a method of selecting an energy producer to supply electricity to an electric generating plant of claim 11 comprising constructing using the computer system alternative terms as label attributes for a plurality of data fields within a database;
autotransposing using the computer system the plurality of data fields within the database by selecting the alternative term label attribute to change every instance of the selected word to the alternative term in all of the plurality of data fields.

14. The non-transitory computer-readable media including computer instructions for performing a method of selecting an energy producer to supply electricity to an electric generating plant of claim 11 comprising constructing using the computer system data entry product specific proposal forms with range and threshold requirements specific to the products and technologies of an energy producer.

15. The non-transitory computer-readable media including computer instructions for performing a method of selecting an energy producer to supply electricity to an electric generating plant of claim 11 comprising displaying using the computer system location information related to each energy producer with an icon identifying the type of energy product.

17. The non-transitory computer-readable media including computer instructions for performing a method of selecting an energy producer to supply electricity to an electric generating plant of claim 12 comprising constructing using the computer system a confidential bid book comprising the file folder structure specified within the bid submission form for storing bid submission data from the specific energy producer in a confidential bid book.

18. The non-transitory computer-readable media including computer instructions for performing a method of selecting an energy producer to supply electricity to an electric generating plant of claim 17 comprising storing and identically naming uploaded documents in a standardized format specified by the bid submission form; storing uploaded documents within the confidential bid book.

19. The non-transitory computer-readable media including computer instructions for performing a method of selecting an energy producer to supply electricity to an electric generating plant of claim 11 comprising sending electronic messages anonymously to distribute data and information to all parties.

20. The non-transitory computer-readable media including computer instructions for performing a method of selecting an energy producer to supply electricity to an electric generating plant of claim 11 comprising accepting at least one of aggregate offers, inclusive offers and exclusive offers.
